(19) United States
(12) Patent Application Publication
(10) Pub. No.: US 2026/0238053 A1
(43) Pub. Date: Aug. 13, 2026

(54) ROTARY ELECTRIC MACHINE, ROTARY ELECTRIC MACHINE UNIT, AND ELECTRIC VEHICLE

(71) Applicant: Mitsubishi Electric Mobility Corporation, Tokyo (JP)

(72) Inventors: Kengo KUMAGAI, Tokyo (JP); Takeshi KUBOTA, Tokyo (JP); Shinsuke KAYANO, Tokyo (JP)

(73) Assignee: Mitsubishi Electric Mobility Corporation, Tokyo (JP)

(21) Appl. No.: 19/155,722

(22) PCT Filed: May 17, 2023
(86) PCT No.: PCT/JP2023/018388

§ 371 Date: Aug. 12, 2025

(51) Int. Cl. H02K 1/276; B60K 1/00; B60L 15/00; H02K 1/16; H02K 1/32; H02K 7/08; H02K 7/116; H02K 9/19; H02K 11/33; H02K 21/14

(52) U.S. Cl. CPC H02K 1/276; B60K 1/00; B60L 15/007; H02K 1/165; H02K 1/32; H02K 7/083; H02K 7/116; H02K 9/19; H02K 11/33; H02K 21/14; H02K 2201/06

(57) ABSTRACT

A rotary electric machine includes: a rotor including a first permanent magnet and a second permanent magnet, for each pole; and a stator including a stator core and a winding. The first permanent magnet is placed at a position advanced in a forward rotation direction of the rotor with respect to a d axis of the rotor, and the second permanent magnet is placed at a delayed position. On the basis of a difference between heat generation levels of the first permanent magnet and the second permanent magnet which generate heat through operation of the rotary electric machine, one of the permanent magnets is defined as a high-heat-generation magnet, and the other is defined as a low-heat-generation magnet. The rotor is formed with heat release performance of the high-heat-generation magnet made greater than heat release performance of the low-heat-generation magnet, and is cooled by heat transfer via a fluid.

### TECHNICAL FIELD

The present disclosure relates to a rotary electric machine, a rotary electric machine unit, and an electric vehicle.

### BACKGROUND ART

Electric vehicle rotary electric machines are required to have a reduced size and an increased output, and it is effective to enhance uniformity of the temperature distribution in a rotary electric machine and reduce the maximum temperature. In such an electric vehicle rotary electric machine, a permanent magnet synchronous motor (PMSM) which has permanent magnets in a rotor is often used for the purpose of higher torque.

In a rotary electric machine of conventional art described in Patent Document 1, a coil formed by winding a coil wire around a stator core is configured such that a heat generation amount in the coil wire at a part where heat is readily released on a heat release path from the coil is large and a heat generation amount in the coil wire at a part where heat is less released on the heat release path from the coil is small. Thus, a temperature distribution difference inside the coil can be reduced, whereby the maximum temperature of the coil can be reduced.

### CITATION LIST

### Patent Document

Patent Document 1: Japanese Laid-Open Patent Publication No. 2006-14471

### SUMMARY OF THE INVENTION

### Problem to be Solved by the Invention

In the conventional art described in Patent Document 1, the temperature distribution inside the coil is adjusted through increase and decrease in sectional areas of the coil wire, and uniformity of the temperature distribution in the rotor having permanent magnets cannot be enhanced.

The present disclosure has been made to solve the above problem, and an object of the present disclosure is to provide a rotary electric machine which has permanent magnets in a rotor and which has enhanced uniformity of the temperature distribution in the rotary electric machine so that the maximum temperature is reduced, thus achieving size reduction and output increase. Another object of the present disclosure is to provide a rotary electric machine unit and an electric vehicle including such a rotary electric machine.

### Means to Solve the Problem

A rotary electric machine according to the present disclosure includes: a cylindrical rotor including at least one first permanent magnet and at least one second permanent magnet, for each pole; and a cylindrical stator including a stator core and a winding and placed with a gap between the stator and the rotor. The first permanent magnet is placed at a position advanced in a forward rotation direction of the rotor with respect to a d axis of the rotor, and the second permanent magnet is placed at a position delayed in the forward rotation direction of the rotor with respect to the d axis of the rotor. On the basis of a difference between heat generation levels of the first permanent magnet and the second permanent magnet which generate heat through operation of the rotary electric machine, one of the first and second permanent magnets is defined as a high-heat-generation magnet, and the other is defined as a low-heat-generation magnet. The rotor is formed with heat release performance of the high-heat-generation magnet made greater than heat release performance of the low-heat-generation magnet, and is cooled by heat transfer via a fluid.

A rotary electric machine unit according to the present disclosure includes: the above rotary electric machine; and an inverter which performs drive control for the rotary electric machine. The rotor includes a first block having the first permanent magnet for each pole and a second block having the second permanent magnet for each pole, the first and second blocks being arranged in an axial direction. The inverter is placed on one axial end side of the rotary electric machine which is a side close to the block having the low-heat-generation magnet, of the first and second blocks.

Another rotary electric machine unit according to the present disclosure includes: the above rotary electric machine; and a speed reducer connected to the rotary electric machine. The rotor includes a first block having the first permanent magnet for each pole and a second block having the second permanent magnet for each pole, the first and second blocks being arranged in an axial direction. The speed reducer is placed on one axial end side of the rotary electric machine which is a side close to the block having the low-heat-generation magnet, of the first and second blocks.

An electric vehicle according to the present disclosure includes the above rotary electric machine and is driven by the rotary electric machine. The forward rotation direction of the rotor is a main rotation direction and is a rotation direction when the electric vehicle moves forward.

### Effect of the Invention

With the rotary electric machine according to the present disclosure, it becomes possible to provide a rotary electric machine which has permanent magnets in a rotor and which has enhanced uniformity of the temperature distribution in the rotary electric machine so that the maximum temperature is reduced, thus achieving size reduction and output increase.

Further, it becomes possible to provide a rotary electric machine unit and an electric vehicle including such a rotary electric machine.

### BRIEF DESCRIPTION OF THE DRAWINGS

FIG. 1 is a block diagram showing a system configuration of an electric vehicle according to embodiment 1.

FIG. 2 is a sectional view showing a schematic structure of the rotary electric machine according to embodiment 1.

FIG. 3 is a sectional view showing a structure of a rotor according to embodiment 1.

FIG. 4 is a perspective view illustrating a structure for one pole of the rotor according to embodiment 1.

FIG. 5 is a sectional view showing a structure of a first block for one pole of the rotor according to embodiment 1.

FIG. 6 is a sectional view showing a structure of a second block for one pole of the rotor according to embodiment 1.

FIG. 7 shows a field magnet position in the first block of the rotor according to embodiment 1, using an electrical angle.

FIG. 8 shows a field magnet position in the second block of the rotor according to embodiment 1, using an electrical angle.

FIG. 9 is a sectional view showing structures of a rotor and a stator according to embodiment 2.

FIG. 10 shows a tooth portion in an axial-direction end region according to embodiment 2.

FIG. 11 shows a tooth portion in an axial-direction center region according to embodiment 2.

FIG. 12 shows a tooth portion in the axial-direction center region in another example according to embodiment 2.

FIG. 13 is a sectional view showing a structure of a rotor according to embodiment 3.

FIG. 14 is a sectional view showing a structure of a first block for one pole of the rotor according to embodiment 3.

FIG. 15 is a sectional view showing a structure of a second block for one pole of the rotor according to embodiment 3.

FIG. 16 is a sectional view showing a structure of a rotor according to embodiment 4. is a view.

FIG. 17 is a block diagram showing a system configuration of an electric vehicle according to embodiment 5.

FIG. 18 is a sectional view showing a structure of a first block for one pole of a rotor according to embodiment 6.

FIG. 19 is a sectional view showing a structure of a second block for one pole of the rotor according to embodiment 6.

FIG. 20 is a sectional view showing a schematic structure of a rotary electric machine unit according to embodiment 7.

FIG. 21 shows the details of a part of FIG. 20.

FIG. 22 is a sectional view showing a schematic structure of a rotary electric machine unit according to embodiment 8.

FIG. 23 shows the details of a part of FIG. 22.

FIG. 24 is a sectional view showing a structure of a rotor according to embodiment 9.

FIG. 25 is a sectional view showing a structure for one pole of the rotor according to embodiment 9.

FIG. 26 shows a field magnet position in the rotor according to embodiment 9, using an electrical angle.

FIG. 27 is a sectional view showing a structure for one pole of a rotor according to embodiment 10.

FIG. 28 is a block diagram showing a system configuration of an electric vehicle in another example according to embodiment 10.

FIG. 29 is a sectional view showing a schematic structure of the rotary electric machine in another example of embodiments 1 to 10.

### DESCRIPTION OF EMBODIMENTS

### Embodiment 1

Hereinafter, embodiment 1 will be described with reference to the drawings.

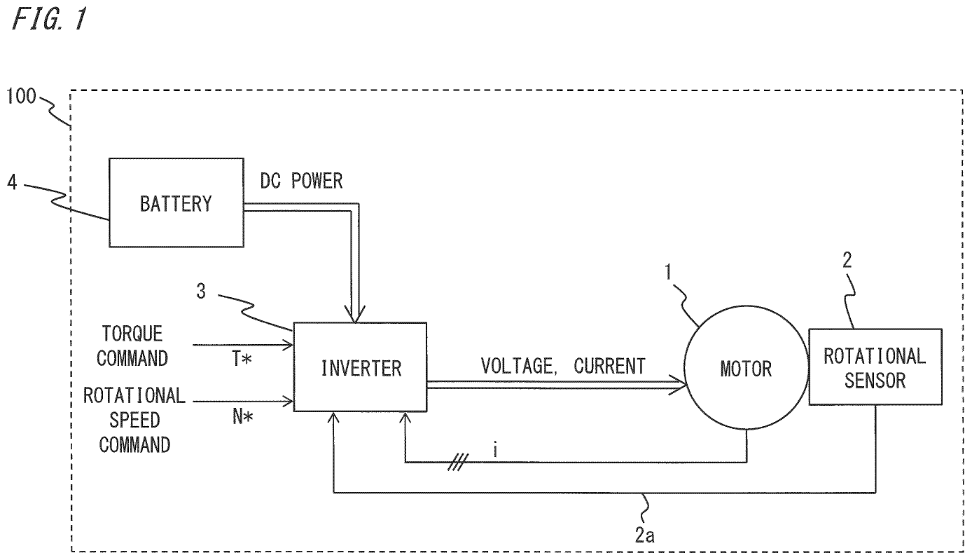

FIG. 1 is a block diagram showing a system configuration of an electric vehicle according to embodiment 1.

As shown in FIG. 1, an electric vehicle 100 includes a motor which is a rotary electric machine 1 for driving the electric vehicle 100, a rotational sensor 2 provided to the rotary electric machine 1, an inverter 3 which performs drive control for the rotary electric machine 1, and a battery 4 which supplies power to the inverter 3.

As the rotational sensor 2, a resolver, an encoder, a MR sensor (Magneto Resistive Sensor), or the like is used. The rotational sensor 2 acquires rotational speed information 2a such as an angular velocity or an angle of the rotary electric machine 1.

The inverter 3 is connected to the battery 4, converts DC power from the battery 4 to AC power, and supplies the AC power to the rotary electric machine 1. Currents i for phases (U phase, V phase, W phase) of the rotary electric machine 1 are detected, and the respective phase currents i and the rotational speed information 2a from the rotational sensor 2 are fed back to the inverter 3.

The inverter 3 receives a torque command T* and a rotational speed command N* for the electric vehicle 100. Then, on the basis of the torque command T*, the rotational speed command N*, the respective phase currents i, and the rotational speed information 2a, the inverter 3 converts DC power from the battery 4 to AC power, and supplies voltage and current of the AC power to the rotary electric machine 1, to perform drive control for the rotary electric machine 1.

In the present embodiment, the rotary electric machine 1 is a drive motor which is driven in a power-running region for a time not shorter than half the life cycle of the electric vehicle 100, i.e., which mainly performs power-running operation.

The rotation direction of the rotary electric machine 1 when the electric vehicle 100 moves forward is defined as a forward rotation direction.

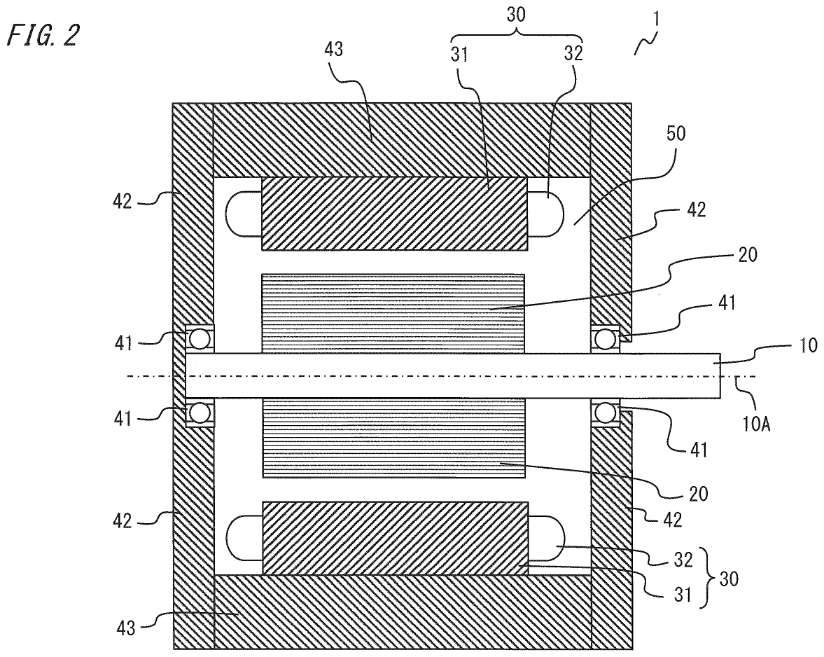

FIG. 2 is a sectional view showing a schematic structure of the rotary electric machine 1 and shows a cross-section along a plane including the axis of the rotary electric machine 1.

As shown in FIG. 2, the rotary electric machine 1 includes a columnar shaft 10, a cylindrical rotor 20 fixed to the shaft 10, and a cylindrical stator 30 provided on the outer side of the rotor 20 with a gap therebetween. The rotor 20 and the stator 30 are arranged concentrically on an axis 10A.

The shaft 10 is rotatably supported by bearings 41, the bearings 41 are fitted to brackets 42, and the brackets 42 are fastened to the housing 43 using fastening means such as screws or the like. The stator 30 is fixed to the housing 43.

The inside of the rotary electric machine 1 is filled with air 50 which is a fluid, and heat generated in the rotor 20 is released through the air 50 in the rotary electric machine 1 and the shaft 10. That is, the rotor 20 is cooled by heat transfer via the air 50 and the shaft 10.

The stator 30 is an armature including a stator core 31 formed by stacking annular-shaped electromagnetic steel sheets in the axial direction, and a coil 32 wound around each tooth (not shown) of the stator core 31. A plurality of teeth are provided at equal intervals in the circumferential direction. The coil 32 has a coil part placed in a slot of the stator core 31 and coil ends protruding toward both sides in the axial direction from the stator core 31. In FIG. 2, the coil parts placed in the slots are not shown, for convenience sake.

In this case, the rotary electric machine 1 is configured with three phases (U phase, V phase, W phase), and the stator 30 has coils for three phases, as the coil 32. Ends of the respective phase coils are connected to AC ends of the inverter 3. The stator 30 may have a plurality of sets (e.g., two sets) of coils for three phases.

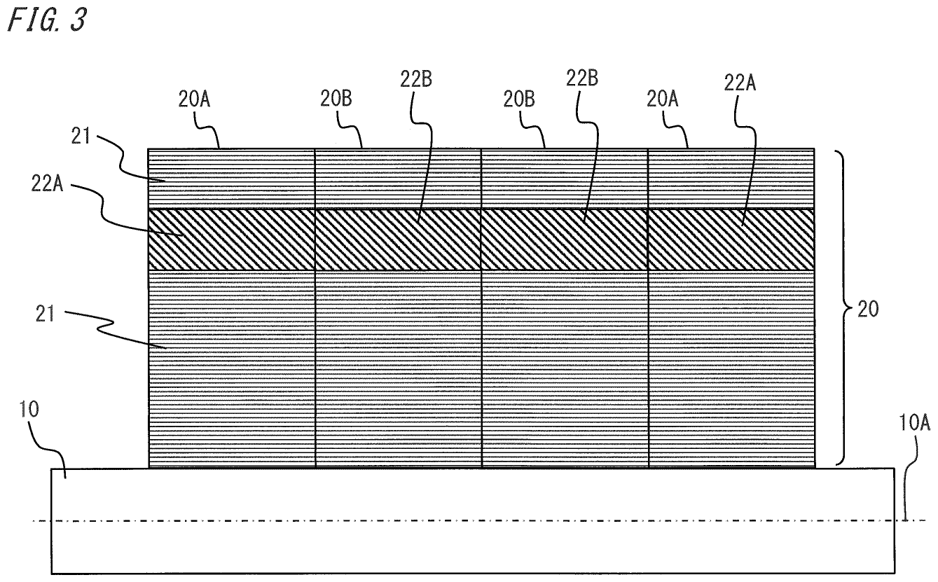

FIG. 3 is a sectional view showing a structure of the rotor 20, and schematically shows a cross-section along a plane including the axis 10A of the rotary electric machine 1.

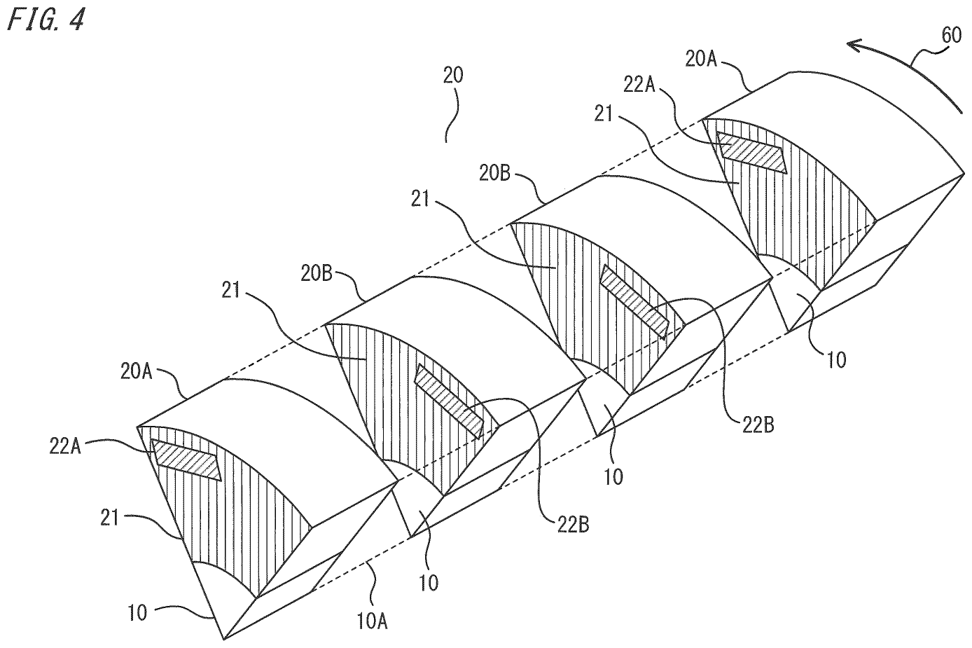

FIG. 4 is a perspective view illustrating a structure for one pole of the rotor 20.

As shown in FIG. 3 and FIG. 4, the rotor 20 includes a rotor core 21 and first and second permanent magnets 22A and 22B which are field magnets, and is composed of blocks 20A and 20B in a plurality of stages (here, four stages) in the axial direction. Of the blocks 20A and 20B in the plurality of stages, the first blocks 20A on the axial-direction end sides include first permanent magnets 22A, and the second blocks 20B on the axial-direction center side include second permanent magnets 22B.

The first and second blocks 20A and 20B are formed by being stacked in the axial direction while being skewed between the stages. The skew angles are set at (±360°/number of poles/order of component to be reduced/2) in mechanical angle so that order components to be reduced in torque ripple are canceled out with each other. In this case, the rotor 20 has eight poles and the skew angle is set at ±1.875° so as to reduce a twelfth-order component.

The forward rotation direction (arrow 60) which is a main rotation direction of the rotor 20 is a direction in which the rotor 20 rotates when the electric vehicle 100 moves forward, and is a counterclockwise direction as seen from the near side in FIG. 4. The positive direction of the skew angle is the forward rotation direction of the rotor 20.

The first and second blocks 20A and 20B have skew angles symmetric with respect to the axial direction so that the skew angle of the first block 20A is set at +1.875° and the skew angle of the second block 20B is set at −1.875°. Thus, the first permanent magnet 22A is placed at a position advanced by +1.875° in the forward rotation direction of the rotor 20, and the second permanent magnet 22B is placed at a position delayed by −1.875° in the forward rotation direction of the rotor 20.

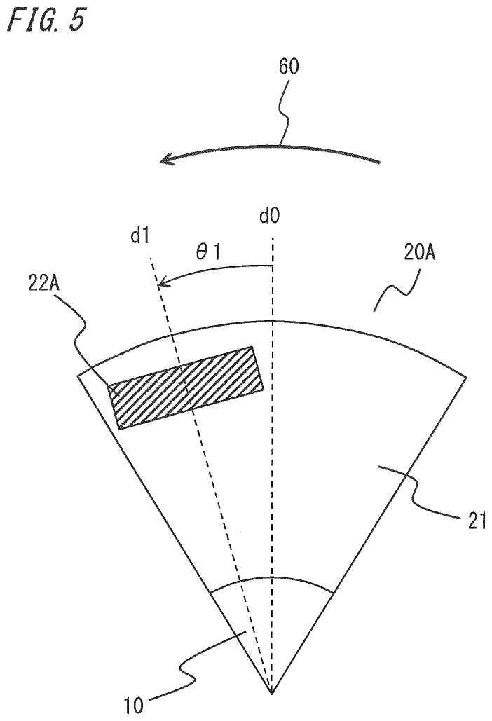

FIG. 5 is a sectional view showing a structure of the first block 20A for one pole of the rotor 20, and shows a cross-section perpendicular to the axial direction.

As shown in FIG. 5, a d axis d1 of the single first block 20A, which is a line connecting the center of the first permanent magnet 22A and the rotation center, is at a position advanced by θ1 (+1.875°) in the forward rotation direction (arrow 60) of the rotor 20 from a d axis do of the entire rotor 20.

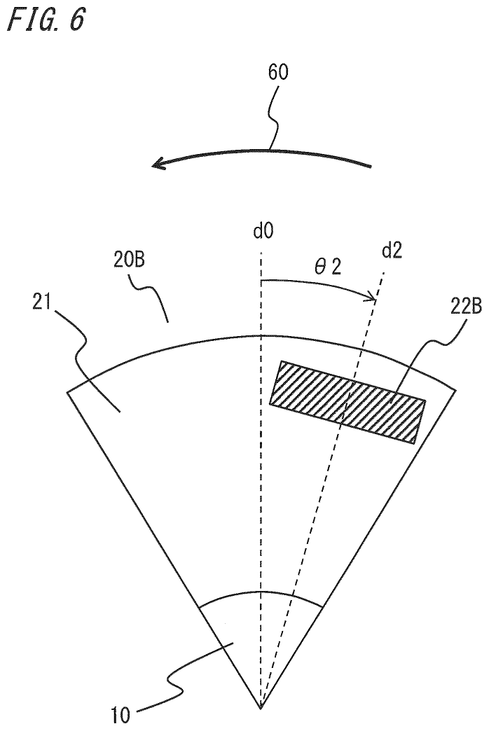

FIG. 6 is a sectional view showing a structure of the second block 20B for one pole of the rotor 20, and shows a cross-section perpendicular to the axial direction.

As shown in FIG. 6, a d axis d2 of the single second block 20B, which is a line connecting the center of the second permanent magnet 22B and the rotation center, is at a position delayed by θ2 (−1.875°) in the forward rotation direction (arrow 60) of the rotor 20 from the d axis do of the entire rotor 20.

When the d axis d1 of the first block 20A and the d axis d2 of the second block 20B are projected on the same plane perpendicular to the axial direction, a vector DO indicating the direction of the d axis do of the entire rotor 20 is represented by the following formula.

$$D 0 = ( L 1 / ( L 1 + L 2 ) ) \cdot D 1 + ( L 2 / ( L 1 + L 2 ) ) \cdot D 2$$

Here, L1 is the axial-direction length of the first block 20A, L2 is the axial-direction length of the second block 20B, D1 is a two-dimensional direction vector when d1 is projected on the plane, and D2 is a two-dimensional direction vector when d2 is projected on the plane. In this case, L1=L2, and do is just at the middle position between d1 and d2.

In a case where the rotary electric machine 1 performs power-running operation, generally, a certain advance angle β is given for the purpose of utilization of reluctance torque or flux weakening control. The advance angle is set with a q axis q0 of the entire rotor 20 as a reference. In the case of power-running operation, β is in a range of 0°<β<90°.

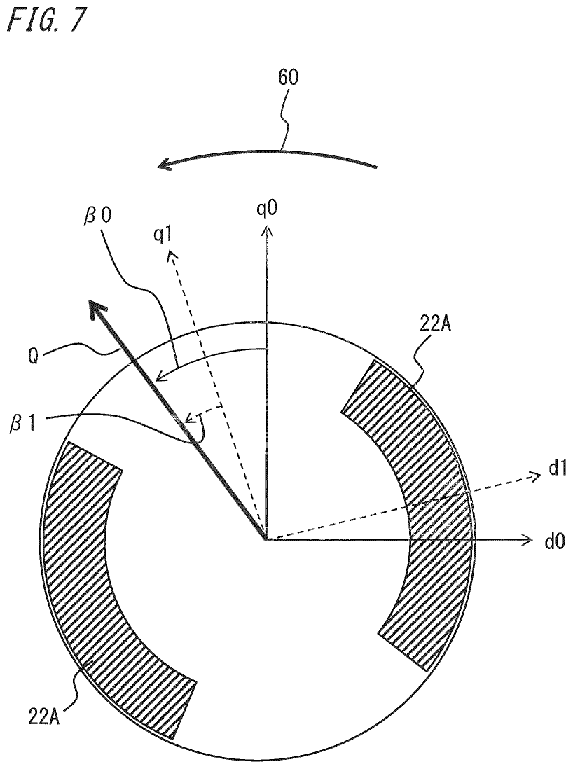

FIG. 7 shows a field magnet position in the first block 20A of the rotor 20, using an electrical angle. As shown in FIG. 7, a magnetic flux vector Q from the stator 30 has an advance angle β0 with the q axis q0 of the entire rotor 20 as a reference, and an advance angle β1 with a q axis q1 of the first block 20A as a reference. The d axis d1 of the first block 20A is at a position advanced in the forward rotation direction (arrow 60) of the rotor 20 from the d axis do of the rotor 20.

The advance angles β0 and β1 have a relationship of β1=β0−θ1×(number of poles), and in this case, β1=β0−15°.

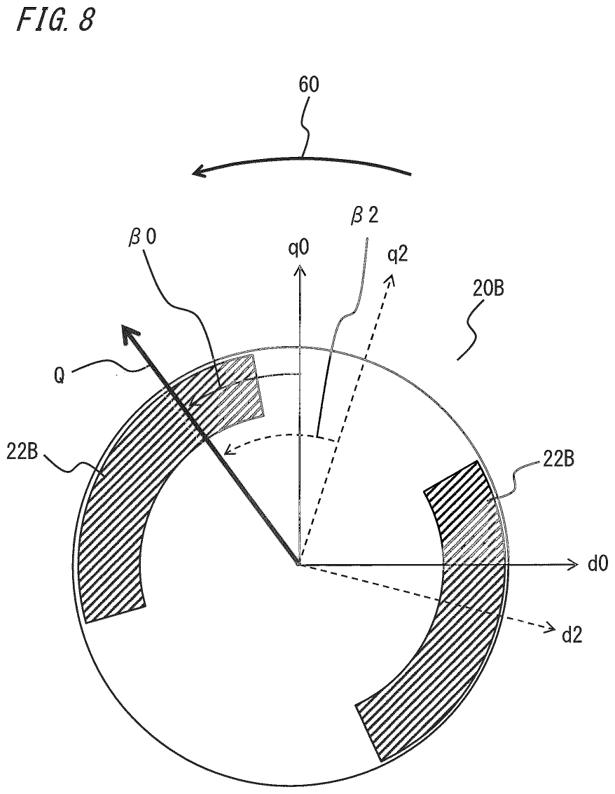

FIG. 8 shows a field magnet position in the second block 20B of the rotor 20, using an electrical angle. As shown in FIG. 8, the magnetic flux vector Q from the stator 30 has an advance angle 30 with the q axis q0 of the entire rotor 20 as a reference, and an advance angle 32 with the q axis q2 of the second block 20B as a reference. The d axis d2 of the second block 20B is at a position delayed in the forward rotation direction (arrow 60) of the rotor 20 from the d axis do of the rotor 20.

The advance angles β0 and β2 have a relationship of β2=β0−θ2×(number of poles), and in this case, β2=β0+15°.

Since the advance angle 30 is defined with the q axis q0 of the entire rotor 20 as a reference, the advance angle β2 with the q axis q2 of the second block 20B as a reference is greater than the advance angle β1 with the q axis q1 of the first block 20A as a reference. That is, the second block 20B has an advance angle closer to 90 degrees than the first block 20A and is larger in a magnetic flux weakening amount. In general, when flux weakening control is performed, iron loss occurring in the rotor 20 is reduced, so that the second block 20B becomes smaller in the heat generation amount than the first block 20A.

That is, the first block 20A is larger in the heat generation amount than the second block 20B. Similarly, the first permanent magnet 22A is larger in the heat generation amount than the second permanent magnet 22B. Thus, the first permanent magnet 22A becomes a high-heat-generation magnet, and the second permanent magnet 22B becomes a low-heat-generation magnet.

In the present embodiment, the first block 20A is placed on the axial-direction end side, and the second block 20B is placed on the axial-direction center side. Thus, since the first block 20A which is larger in the heat generation amount is placed on the axial-direction end side, the first block 20A has a larger contact area with the air 50 in the rotary electric machine 1 and readily releases heat from the axial end. In addition, the first block 20A is closer to also the end of the shaft 10 and therefore readily releases heat through the shaft 10 to the outside air.

As described above, heat release performance of the first block 20A which is larger in the heat generation amount is made greater than heat release performance of the second block 20B, so that the temperature distribution between the first block 20A and the second block 20B is uniformed. Thus, the maximum temperature of the entire rotor 20 can be reduced, whereby size reduction and output increase of the rotary electric machine 1 can be achieved.

Heat generation in the rotor 20 is mainly heat generation from the first and second permanent magnets 22A and 22B which are field magnets. In this case, making heat release performance of the first block 20A greater than heat release performance of the second block 20B is the same as making heat release performance of the first permanent magnet 22A greater than heat release performance of the second permanent magnet 22B.

As described above, in the present embodiment, on the basis of difference between heat generation levels of the first permanent magnet 22A and the second permanent magnet 22B which generate heat through operation of the rotary electric machine 1, the first permanent magnet 22A is set as a high-heat-generation magnet, the second permanent magnet 22B is set as a low-heat-generation magnet, and the rotor 20 is formed with heat release performance of the high-heat-generation magnet made greater than heat release performance of the low-heat-generation magnet, and is cooled by heat transfer via a fluid.

Thus, uniformity of the temperature distribution in the rotary electric machine 1 is enhanced and the maximum temperature is reduced, whereby size reduction and output increase of the rotary electric machine 1 can be achieved.

In the present embodiment, the rotor 20 includes blocks arranged in a plurality of stages in the axial direction and composed of at least one first block 20A having the first permanent magnet 22A for each pole and at least one second block 20B having the second permanent magnet 22B for each pole. Of the blocks in the plurality of stages, the block having the high-heat-generation magnet is placed on the axial-direction end side, and the block having the low-heat-generation magnet is placed on the axial-direction center side.

Thus, heat release performance of the high-heat-generation magnet can be easily and assuredly made greater than heat release performance of the low-heat-generation magnet, whereby the rotor 20 can be effectively cooled.

In the above embodiment, the rotor 20 has blocks in four stages in the axial direction. However, the number of stages may be other than four as long as the first block 20A is placed on the axial-direction end side and the second block 20B is placed on the axial-direction center side.

In the above embodiment, the case where the rotor 20 is cooled via the air 50 and the shaft 10 has been shown. However, the fluid is not limited to the air 50, and may be oil, for example.

In a case where the rotary electric machine 1 performs regeneration operation, the second block 20B in which the second permanent magnet 22B is placed at a position delayed in the forward rotation direction of the rotor 20 is larger in the heat generation amount than the first block 20A. The above advance angle β is in a range of 0°<β<90° in power-running operation, whereas the advance angle β is in a range of 90°<β<180° in regeneration operation. That is, in a case of regeneration, in the first block set at a phase-advanced position, β becomes closer to 90 degrees and the magnetic flux weakening amount becomes larger, so that the heat generation amount is reduced. Therefore, the second block 20B becomes larger in the heat generation amount.

In the above embodiment, the rotary electric machine 1 is described as a drive motor which mainly performs power-running operation. However, the electric vehicle 100 may include a rotary electric machine serving as an electric generator, separately from the drive motor. In a case where the rotary electric machine 1 is an electric generator which mainly performs regeneration operation, the following configuration is applied.

In the case where the rotary electric machine 1 is an electric generator which mainly performs regeneration operation, the second block 20B in which the second permanent magnet 22B is placed at a position delayed in the forward rotation direction of the rotor 20 is larger in the heat generation amount than the first block 20A in which the first permanent magnet 22A is placed at a position advanced in the forward rotation direction of the rotor 20. Similarly, the second permanent magnet 22B becomes larger in the heat generation amount than the first permanent magnet 22A, the second permanent magnet 22B becomes a high-heat-generation magnet, and the first permanent magnet 22A becomes a low-heat-generation magnet.

The second block 20B is placed on the axial-direction end side of the rotor 20, and the first block 20A is placed on the axial-direction center side. This corresponds to a configuration in which arrangement of the first blocks 20A and the second blocks 20B in FIG. 3 and FIG. 4 is reversed, and this is not shown, for convenience sake.

Also in this case, the rotor 20 is formed with heat release performance of the high-heat-generation magnet (second permanent magnet 22B) made greater than heat release performance of the low-heat-generation magnet (first permanent magnet 22A), and is cooled by heat transfer via a fluid. Thus, uniformity of the temperature distribution in the rotary electric machine 1 is enhanced and the maximum temperature is reduced, whereby size reduction and output increase of the rotary electric machine 1 can be achieved.

### Embodiment 2

Next, embodiment 2 will be described with reference to the drawings.

In the present embodiment 2, the structure of the stator 30 is different from that of the rotary electric machine 1 shown in the above embodiment 1.

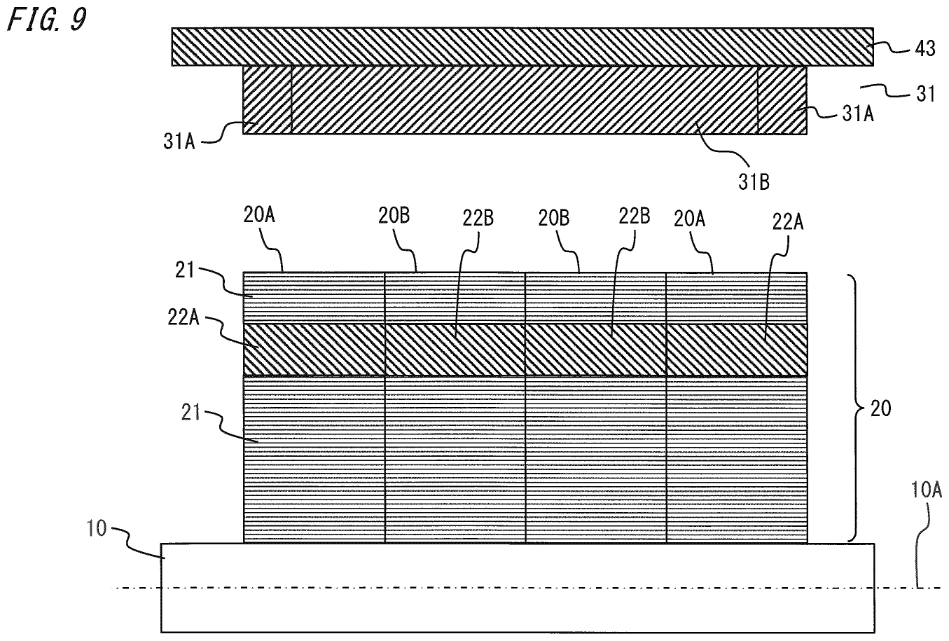

FIG. 9 is a sectional view showing structures of a rotor and a stator according to embodiment 2, and schematically shows a cross-section along a plane including the axis 10A of the rotary electric machine 1.

As shown in FIG. 9, the structure of the rotor 20 is the same as that in the above embodiment 1, and the stator core 31 of the stator 30 provided on the outer side of the rotor 20 with a gap therebetween is formed such that the shapes of tooth portions are different between axial-direction end regions 31A of the stator core 31 and an axial-direction center region 31B located between the axial-direction end regions 31A on both sides.

The stator core 31 has a tooth portion protruding toward the rotor 20 side, here, protruding from the outer circumferential side to the inner circumferential side, and formed by being stacked in the axial direction, and a plurality of teeth formed by the stacked tooth portions are provided at equal intervals in the circumferential direction.

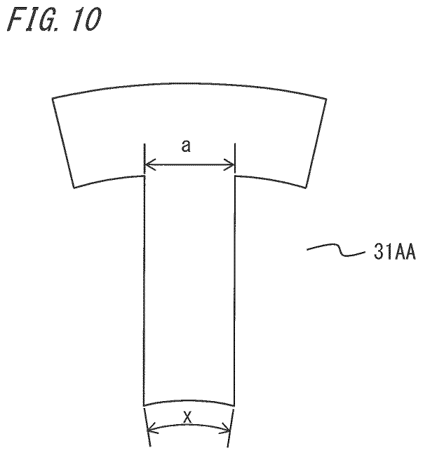

FIG. 10 shows a tooth portion in the axial-direction end region 31A.

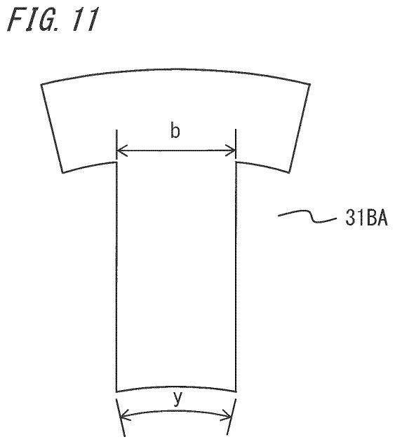

FIG. 11 shows a tooth portion in the axial-direction center region 31B.

As shown in FIG. 10, a tooth portion 31AA in the axial-direction end region 31A is formed such that a distal end angle of the tooth portion 31AA is x [°] and a base end width of the tooth portion 31AA is a [mm]. As shown in FIG. 11, a tooth portion 31BA in the axial-direction center region 31B is formed such that a distal end angle of the tooth portion 31BA is y (>x) [°] and a base end width of the tooth portion 31BA is b (>a) [mm]. When the distal end angle is great, the distal end width is also great.

In the present embodiment, the distal end width and the base end width of the tooth portion 31AA in the axial-direction end region 31A are smaller than those of the tooth portion 31BA in the axial-direction center region 31B. Therefore, the tooth portion 31AA in the axial-direction end region 31A has a smaller magnetic path width than the tooth portion 31BA in the axial-direction center region 31B, and is more likely to be magnetically saturated.

Thus, in the stator 30, loss is smaller in the axial-direction end region 31A than in the axial-direction center region 31B. In addition, a magnetic flux extending from the tooth portion 31AA in the axial-direction end region 31A to the rotor 20 is also reduced, so that loss occurring in the corresponding region in the rotor 20 is also reduced.

As described above, in the rotor 20, the first block 20A which is larger in the heat generation amount is placed on the axial-direction end side, and the second block 20B which is smaller in the heat generation amount is placed on the axial-direction center side. This rotor 20 is combined with the stator 30 in which the tooth portion 31AA in the axial-direction end region 31A is narrower than the tooth portion 31BA in the axial-direction center region 31B, whereby uniformity of the temperature distribution in the rotary electric machine 1 is enhanced and the maximum temperature can be further reduced.

In addition, since the tooth portion 31AA in the axial-direction end region 31A is narrower than the tooth portion 31BA in the axial-direction center region 31B, it becomes easy to wind the coil 32.

In the stator core 31 according to the above embodiment, the tooth portion 31AA in the axial-direction end region 31A is smaller in the distal end width and the base end width than the tooth portion 31BA in the axial-direction center region 31B. However, the same effects are obtained also in a case where at least one of the distal end width and the base end width is smaller.

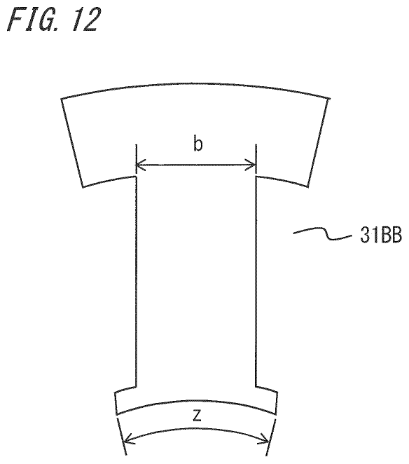

FIG. 12 shows a tooth portion in the axial-direction center region 31B in another example according to embodiment 2. In this case, the tooth portion 31AA shown in FIG. 10 is used in the axial-direction end region 31A.

As shown in FIG. 12, a tooth portion 31BB in the axial-direction center region 31B is formed such that the distal end angle of the tooth portion 31BB is z (>x) [°] and the base end width of the tooth portion 31BB is b (>a) [mm]. In this case, the tooth portion 31BB has a shape in which the width is great only at the distal end, i.e., a shape having brims. In this example, since the distal end width of the tooth portion 31BB is greater than the base end width, the base end width of the tooth portion 31BB may be the same as the base end width of the tooth portion 31AA in the axial-direction end region 31A.

The structure of the stator core 31 in which a plurality of tooth portions 31AA and 31BB having different distal end widths are combined as described above is effective for reduction in torque ripple, and is particularly suitable for the rotary electric machine 1 in which torque ripple is not desirable in usage.

### Embodiment 3

Next, embodiment 3 will be described with reference to the drawings.

In the above embodiment 1, the rotor 20 has blocks in four stages in the axial direction, whereas in the present embodiment 3, a fluid flows in the axial direction and the rotor is formed by two blocks provided on the upstream side and the downstream side of the fluid.

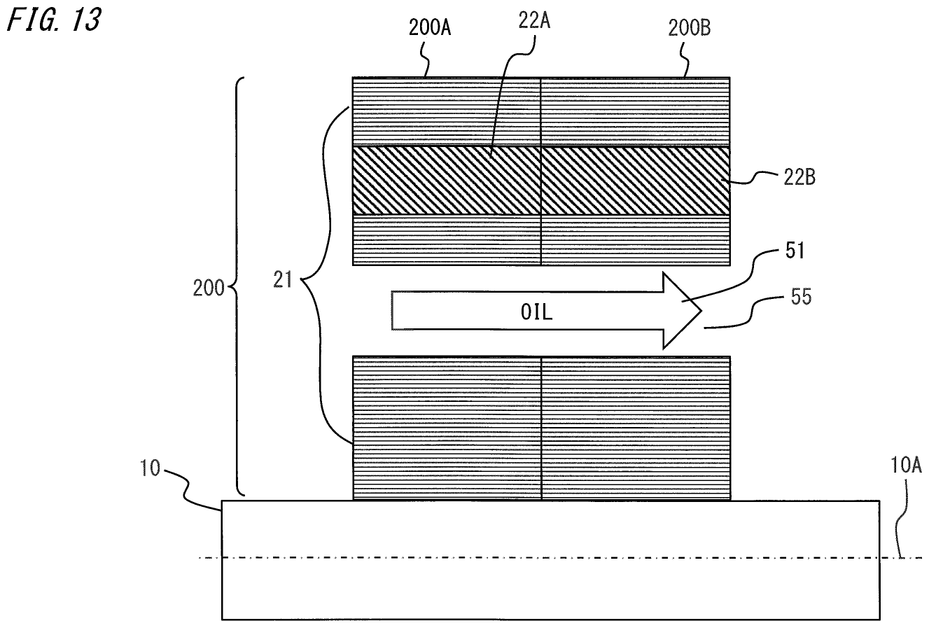

FIG. 13 is a sectional view showing a structure of the rotor according to embodiment 3, and schematically shows a cross-section along a plane including the axis 10A of the rotary electric machine 1.

As shown in FIG. 13, the rotor 200 includes the rotor core 21 and the first and second permanent magnets 22A and 22B, and is cooled by a fluid 51 which is oil flowing through a through hole 55 penetrating in the axial direction. The rotor 200 is composed of a first block 200A on the upstream side of the fluid 51 in the axial direction, and a second block 200B on the downstream side. The first block 200A has the first permanent magnet 22A, and the second block 200B has the second permanent magnet 22B.

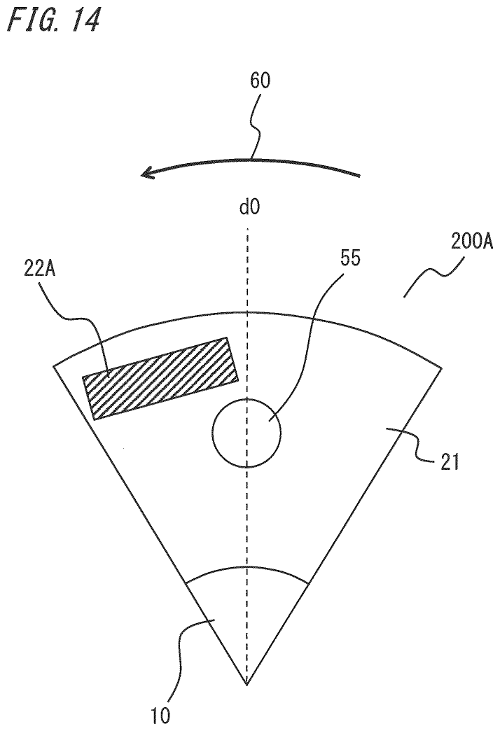

FIG. 14 is a sectional view showing a structure of the first block 200A for one pole of the rotor 200, and shows a cross-section perpendicular to the axial direction.

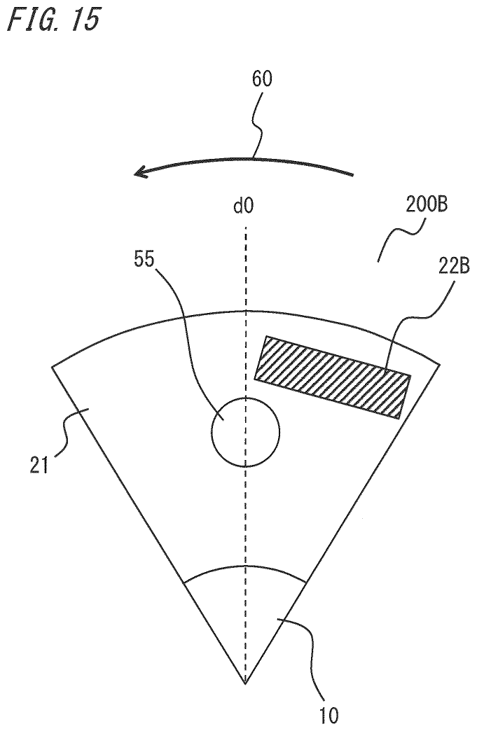

FIG. 15 is a sectional view showing a structure of the second block 200B for one pole of the rotor 200, and shows a cross-section perpendicular to the axial direction.

The first block 200A has the first permanent magnet 22A placed at a position advanced in the forward rotation direction (arrow 60) of the rotor 200, for each pole, as in the above embodiment 1. As in the above embodiment 1, the second block 200B has the second permanent magnet 22B placed at a position delayed in the forward rotation direction (arrow 60) of the rotor 200, for each pole. The through hole 55 penetrating in the axial direction for each pole of the rotor 200 is provided on the d axis do of the entire rotor 200.

As described in the above embodiment 1, in a case where the rotary electric machine 1 performs power-running operation, a certain advance angle is given with the q axis q0 of the entire rotor 200 as a reference, for the purpose of utilization of reluctance torque or flux weakening control. Also in the present embodiment, similarly, the advance angle with the q axis of the second block 200B as a reference is greater than the advance angle with the q axis of the first block 200A as a reference. That is, the second block 200B has an advance angle closer to 90 degrees than the first block 200A and is larger in a magnetic flux weakening amount, so that the heat generation amount in the second block 200B becomes smaller. In this case, the first permanent magnet 22A becomes a high-heat-generation magnet, and the second permanent magnet 22B becomes a low-heat-generation magnet.

In the present embodiment, the rotary electric machine 1 is a drive motor which mainly performs power-running operation, the first block 200A which is larger in the heat generation amount is placed on the upstream side of the fluid 51 in the axial direction, and the second block 200B which is smaller in the heat generation amount is placed on the downstream side. The fluid 51 flowing through the through hole 55 takes heat of the first block 200A and then takes heat of the second block 200B. The fluid 51 contacting with the first block 200A has a lower temperature than the fluid 51 contacting with the second block 200B, and thus has a higher heat drawing effect. Therefore, the temperatures of the first block 200A and the second block 200B can be uniformed.

As described above, heat release performance of the first block 200A which is larger in the heat generation amount is made greater than heat release performance of the second block 200B, whereby the temperature distribution between the first block 200A and the second block 200B is uniformed. Thus, the maximum temperature of the entire rotor 200 can be reduced, whereby size reduction and output increase of the rotary electric machine 1 can be achieved.

Also in this case, making heat release performance of the first block 200A greater than heat release performance of the second block 200B is the same as making heat release performance of the first permanent magnet 22A greater than heat release performance of the second permanent magnet 22B.

In the above embodiment 3, the rotary electric machine 1 is described as a drive motor which mainly performs power-running operation. However, in a case where the rotary electric machine 1 is an electric generator which mainly performs regeneration operation, the following configuration is applied. That is, as described above, the second permanent magnet 22B is higher in the heat generation amount than the first permanent magnet 22A, the second permanent magnet 22B becomes a high-heat-generation magnet, and the first permanent magnet 22A becomes a low-heat-generation magnet. Then, the second block 200B which is larger in the heat generation amount is placed on the upstream side of the fluid 51 in the axial direction, and the first block 200A which is smaller in the heat generation amount is placed on the downstream side.

Also in this case, the rotor 20 is formed with heat release performance of the high-heat-generation magnet (second permanent magnet 22B) made greater than heat release performance of the low-heat-generation magnet (first permanent magnet 22A), and is cooled by heat transfer via the fluid 51. Thus, the uniformity of the temperature distribution in the rotary electric machine 1 is enhanced and the maximum temperature is reduced, whereby size reduction and output increase of the rotary electric machine 1 can be achieved.

### Embodiment 4

Next, embodiment 4 will be described with reference to the drawings.

In the above embodiment 3, the rotor 200 is cooled by the fluid 51 flowing through the through hole 55 provided for each pole of the rotor 200. In the present embodiment 4, without providing a through hole, the rotor is cooled by a fluid flowing in the axial direction in the rotary electric machine 1.

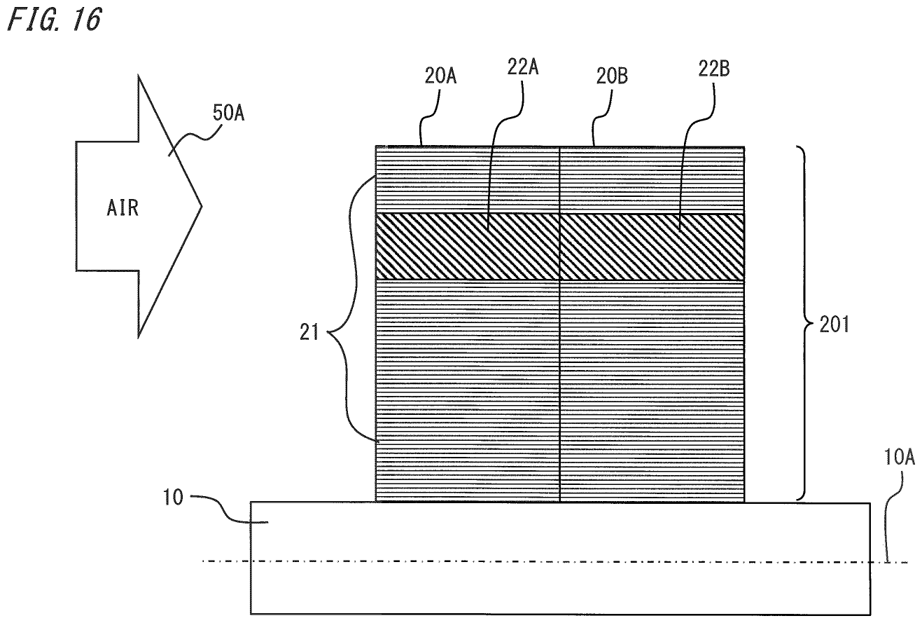

FIG. 16 is a sectional view showing a structure of the rotor according to embodiment 4, and schematically shows a cross-section along a plane including the axis 10A of the rotary electric machine 1. In this case, the rotary electric machine 1 is a drive motor which mainly performs power-running operation.

As shown in FIG. 16, the rotor 201 includes the rotor core 21 and the first and second permanent magnets 22A and 22B, and is cooled by a fluid 50A which is air flowing in the axial direction. The rotor 201 includes the first block 20A on the upstream side of the fluid 50A in the axial direction, and the second block 20B on the downstream side. The first block 20A has the first permanent magnet 22A, and the second block 20B has the second permanent magnet 22B.

The structures of the first and second blocks 20A and 20B are the same as those in the above embodiment 1 (see FIG. 5 and FIG. 6). Also in this case, the first permanent magnet 22A becomes a high-heat-generation magnet, and the second permanent magnet 22B becomes a low-heat-generation magnet.

Also in the present embodiment, as in the above embodiment 3, the first block 20A which is larger in the heat generation amount is placed on the upstream side of the fluid 50A in the axial direction, and the second block 20B which is smaller in the heat generation amount is placed on the downstream side. The fluid 50A flowing in the axial direction takes heat of the first block 20A and then takes heat of the second block 20B. The fluid 50A contacting with the first block 20A has a lower temperature than the fluid 50A contacting with the second block 20B, and thus has a higher heat drawing effect. Therefore, the temperatures of the first block 20A and the second block 20B can be uniformed.

As described above, heat release performance of the first block 20A which is larger in the heat generation amount is made greater than heat release performance of the second block 20B, whereby the temperature distribution between the first block 20A and the second block 20B is uniformed. Thus, the maximum temperature of the entire rotor 201 can be reduced, whereby size reduction and output increase of the rotary electric machine 1 can be achieved.

In addition, the rotary electric machine 1 is an air-passage cooling type without the need of separately providing a through hole, and therefore can be formed with a simple structure.

In the above embodiment 4, the rotary electric machine 1 is described as a drive motor which mainly performs power-running operation. However, in a case where the rotary electric machine 1 is an electric generator which mainly performs regeneration operation, the following configuration is applied. That is, as described above, the second permanent magnet 22B is larger in the heat generation amount than the first permanent magnet 22A, the second permanent magnet 22B becomes a high-heat-generation magnet, and the first permanent magnet 22A becomes a low-heat-generation magnet. Then, the second block 20B which is larger in the heat generation amount is placed on the upstream side of the fluid 50A in the axial direction, and the first block 20A which is smaller in the heat generation amount is placed on the downstream side.

Also in this case, the rotor 201 is formed with heat release performance of the high-heat-generation magnet (second permanent magnet 22B) made greater than heat release performance of the low-heat-generation magnet (first permanent magnet 22A), and is cooled by heat transfer via the fluid 50A. Thus, uniformity of the temperature distribution in the rotary electric machine 1 is enhanced and the maximum temperature is reduced, whereby size reduction and output increase of the rotary electric machine 1 can be achieved.

The fluids 51 and 50A used in the above embodiments 3 and 4 are not limited to oil or air, and may be any fluid having high heat transfer performance.

### Embodiment 5

Next, embodiment 5 will be described with reference to the drawings.

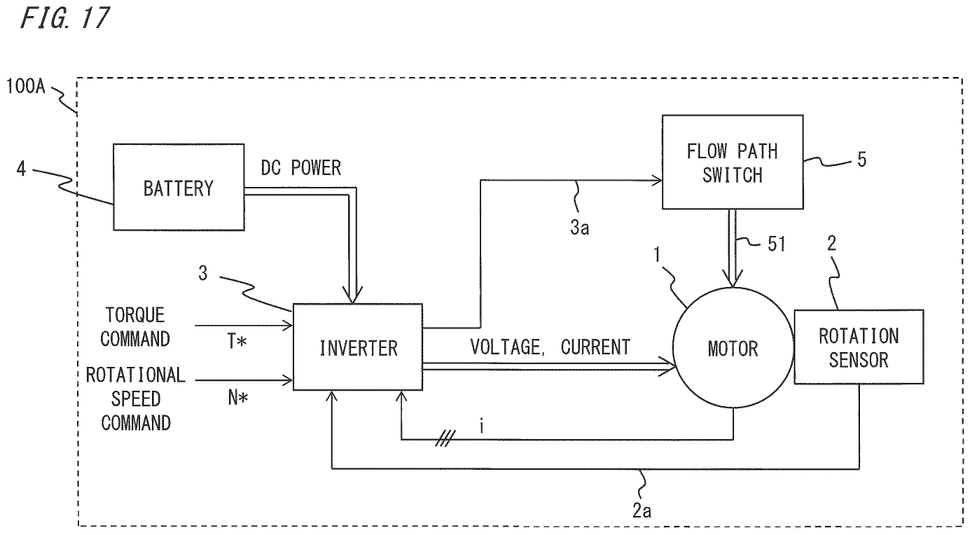

FIG. 17 is a block diagram showing a system configuration of an electric vehicle according to embodiment 5.

As shown in FIG. 17, an electric vehicle 100A includes a motor which is the rotary electric machine 1 for driving the electric vehicle 100A, the rotational sensor 2 provided to the rotary electric machine 1, the inverter 3 which performs drive control for the rotary electric machine 1, the battery 4 which supplies power to the inverter 3, and a flow path switch 5 provided to the rotary electric machine 1.

The rotary electric machine 1, the rotational sensor 2, the inverter 3, and the battery 4 are the same as those described in FIG. 1 in the above embodiment 1, and the structure of the rotor in the rotary electric machine 1 is the same as that in the above embodiment 3 or 4.

Here, an example in which the rotary electric machine 1 according to the above embodiment 3 is used is shown.

As described in the above embodiment 3, the rotor 200 is cooled by the fluid 51 flowing in the axial direction through the through hole 55. The flow path switch 5 inverts the direction of the fluid 51 at the time of switchover between power-running operation and regeneration operation of the rotary electric machine 1. The flow path switch 5 has, for example, a solenoid-type direction switchover valve therein and operates in accordance with a switchover command 3a from the inverter 3.

When the driving condition of the rotary electric machine 1 changes from power-running operation to regeneration operation, the inverter 3 gives the switchover command 3a to the flow path switch 5, so that the flow path switch 5 inverts the flowing direction of the fluid 51. Thus, the fluid 51 flowing from the first block 200A toward the second block 200B in power-running operation is inverted in regeneration operation and flows from the second block 200B toward the first block 200A.

As described above, the first block 200A has the first permanent magnet 22A placed at a position advanced in the forward rotation direction of the rotor 200 for each pole, and the second block 200B has the second permanent magnet 22B placed at a position delayed in the forward rotation direction of the rotor 200 for each pole.

Between the first block 200A and the second block 200B, the first block 200A is larger in the heat generation amount during power-running operation, and the second block 200B is larger in the heat generation amount during regeneration operation.

In the present embodiment, the flow path switch 5 for inverting the flowing direction of the fluid 51 is provided to the rotary electric machine 1. Therefore, not only in power-running operation but also in regeneration operation, the fluid 51 flows from the block that is larger in the heat generation amount toward the block that is smaller in the heat generation amount, between the first block 200A and the second block 200B. Thus, the rotor 200 can be effectively cooled, the temperature distribution between the first block 200A and the second block 200B is uniformed also in regeneration operation, and the maximum temperature of the entire rotor 200 can be reduced.

In the above embodiment, the example in which the rotary electric machine 1 according to the above embodiment 3 is used has been shown. However, the rotary electric machine 1 according to the above embodiment 4 can also be used in the same manner. Also in this case, when the driving condition of the rotary electric machine 1 changes from power-running operation to regeneration operation, the inverter 3 gives the switchover command 3a to the flow path switch 5, so that the flow path switch 5 inverts the flowing direction of the fluid 50A. Thus, the fluid 50A flowing from the first block 20A toward the second block 20B in power-running operation is inverted in regeneration operation and flows from the second block 20B to the first block 20A. Therefore, the rotor 201 can be effectively cooled not only in power-running operation but also in regeneration operation.

The flow path switch 5 is not limited to a type that operates in accordance with a command from the inverter 3, and may perform switchover on the basis of other information, e.g., information on a current value or an angular velocity of the rotary electric machine 1.

The above embodiment 5 is also applicable to the rotary electric machine 1 serving as an electric generator which mainly performs regeneration operation. In this case, the second permanent magnet 22B becomes a high-heat-generation magnet, the first permanent magnet 22A becomes a low-heat-generation magnet, the second block 20B which is larger in the heat generation amount is placed on the upstream side of the fluid 50A in the axial direction, and the first block 20A which is smaller in the heat generation amount is placed on the downstream side. When the driving condition of the rotary electric machine 1 changes from regeneration operation to power-running operation, the flow path switch 5 inverts the flowing direction of the fluid 50A. Thus, the fluid 50A flowing from the second block 20B toward the first block 20A in regeneration operation is inverted in power-running operation and flows from the first block 20A toward the second block 20B. Therefore, the rotor 201 can be effectively cooled not only in regeneration operation but also in power-running operation.

### Embodiment 6

Next, embodiment 6 will be described with reference to the drawings. Here, the rotary electric machine 1 is described as a drive motor which mainly performs power-running operation.

In the above embodiment 3, the through hole 55 penetrating in the axial direction is provided on the d axis do of the rotor 200, whereas in the present embodiment 6, a through hole is provided at a different position.

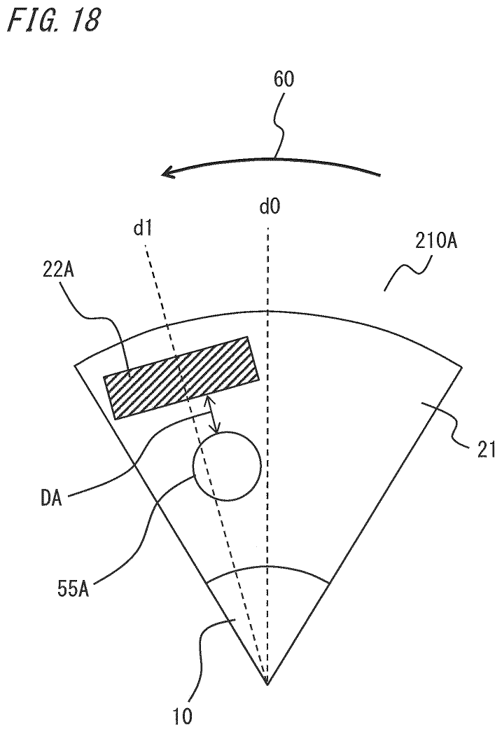

FIG. 18 is a sectional view showing a structure of a first block 210A for one pole of the rotor 200, and shows a cross-section perpendicular to the axial direction.

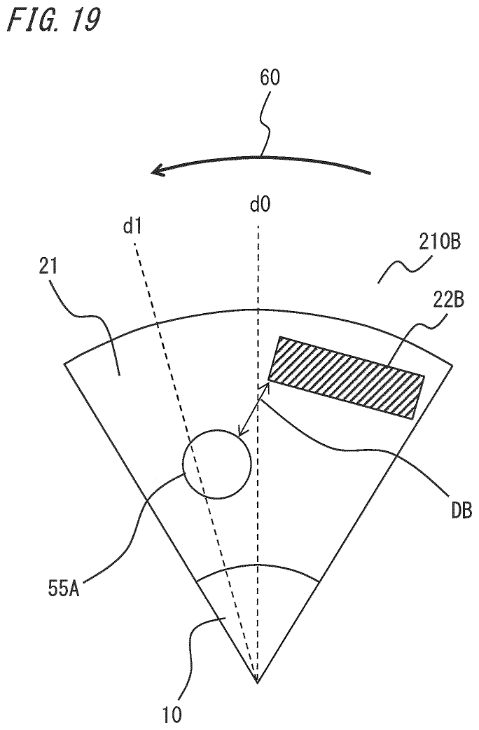

FIG. 19 is a sectional view showing a structure of a second block 210B for one pole of the rotor 200, and shows a cross-section perpendicular to the axial direction.

Also in the present embodiment 6, as in the above embodiment 3, the rotor 200 includes the rotor core 21 and the first and second permanent magnets 22A and 22B, and is cooled by the fluid 51 which is oil flowing through a through hole 55A penetrating in the axial direction. The rotor 200 is composed of the first block 210A on the upstream side of the fluid 51 in the axial direction and the second block 210B on the downstream side, the first block 210A has the first permanent magnet 22A, and the second block 210B has the second permanent magnet 22B.

The first block 210A has the first permanent magnet 22A placed at a position advanced in the forward rotation direction (arrow 60) of the rotor 200, for each pole. The second block 210B has the second permanent magnet 22B placed at a position delayed in the forward rotation direction (arrow 60) of the rotor 200, for each pole. In addition, the through hole 55A penetrating in the axial direction is provided for each pole of the rotor 200.

The through hole 55A is placed on the d axis d1 side of the first block 210A with respect to the d axis do of the rotor 200. That is, the through hole 55A is provided at such a position that a distance DA from the through hole 55A to the first permanent magnet 22A is shorter than a distance DB from the through hole 55A to the second permanent magnet 22B.

In order to make the magnet temperatures of the first permanent magnet 22A and the second permanent magnet 22B equal to each other, it is preferable that the ratio of the distance DA and the distance DB is the reciprocal of the ratio of the heat generation amounts of the first and second permanent magnets 22A and 22B.

In the present embodiment, the through hole 55A penetrating in the axial direction is provided at a position closer to the first permanent magnet 22A which is a high-heat-generation magnet than to the second permanent magnet 22B which is the low-heat-generation magnet. Thus, heat generated in the first permanent magnet 22A of the first block 210A more transfers to the fluid 51 flowing through the through hole 55A than heat generated in the second permanent magnet 22B of the second block 210B. Therefore, heat release performance of the first permanent magnet 22A (high-heat-generation magnet) becomes greater than heat release performance of the second permanent magnet 22B (low-heat-generation magnet).

As described above, heat release performance of the first block 210A which is larger in the heat generation amount can be made greater than heat release performance of the second block 210B which is smaller in the heat generation amount, whereby the temperature distribution between the first block 210A and the second block 210B is uniformed. Thus, the maximum temperature of the entire rotor 200 can be reduced, whereby size reduction and output increase of the rotary electric machine 1 can be achieved.

In the present embodiment, the first block 210A is placed on the upstream side of the fluid 51, and the second block 210B is placed on the downstream side. Owing to this together with the effect based on placement of the through hole 55A, heat release performance of the first block 210A which is larger in the heat generation amount can be further improved, whereby the maximum temperature of the entire rotor 200 can be reduced.

Placement of the first block 210A and the second block 210B is not limited to that in the above embodiment. For example, the first block 210A and the second block 210B may be placed in the same manner as in the above embodiment 1, or may be alternately placed in a total of four stages. Also in these cases, by providing the through hole 55A at a position closer to the first permanent magnet 22A than to the second permanent magnet 22B, heat release performance of the first permanent magnet 22A becomes greater than heat release performance of the second permanent magnet 22B, whereby the maximum temperature of the entire rotor 200 can be reduced.

Also in the present embodiment, the fluid 51 is not limited to oil or air, and may be any fluid having high heat transfer performance.

The above embodiment 6 is also applicable to the rotary electric machine 1 serving as an electric generator which mainly performs regeneration operation. In this case, the second permanent magnet 22B becomes a high-heat-generation magnet, the first permanent magnet 22A becomes a low-heat-generation magnet, the second block 210B which is larger in the heat generation amount is placed on the upstream side of the fluid 51 in the axial direction, and the first block 210A which is smaller in the heat generation amount is placed on the downstream side. In addition, the through hole 55A penetrating in the axial direction is provided for each pole of the rotor 200. In this case, the through hole 55A is placed on the d axis d2 side of the second block 210B with respect to the d axis do of the rotor 200. That is, the through hole 55A is provided at such a position that the distance from the through hole 55A to the second permanent magnet 22B is shorter than the distance from the through hole 55A to the first permanent magnet 22A.

Thus, heat release performance of the second permanent magnet 22B (high-heat-generation magnet) becomes greater than heat release performance of the first permanent magnet 22A (low-heat-generation magnet), whereby the maximum temperature of the entire rotor 200 can be reduced.

### Embodiment 7

Next, embodiment 7 will be described with reference to the drawings. Here, the rotary electric machine 1 is described as a drive motor which mainly performs power-running operation.

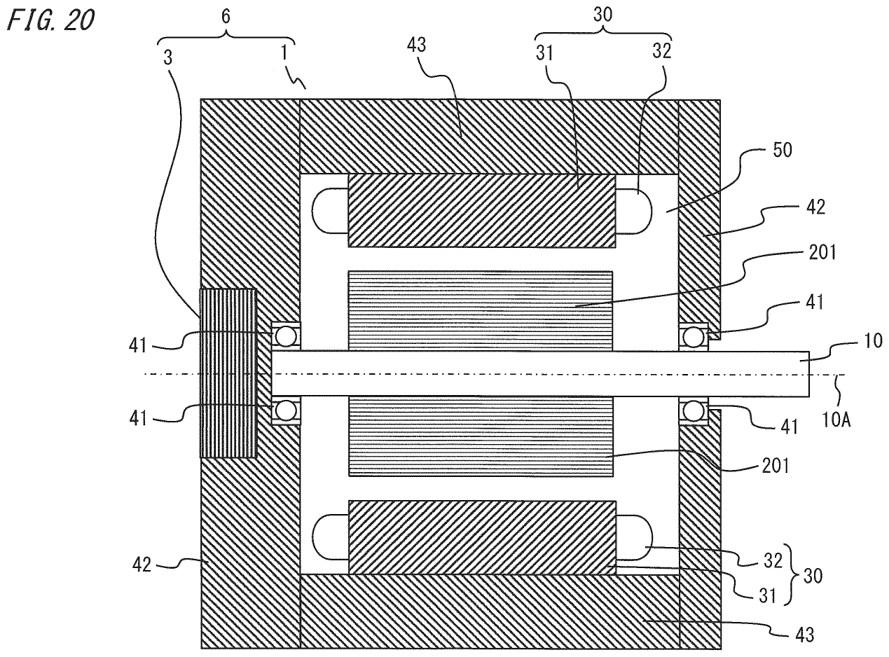

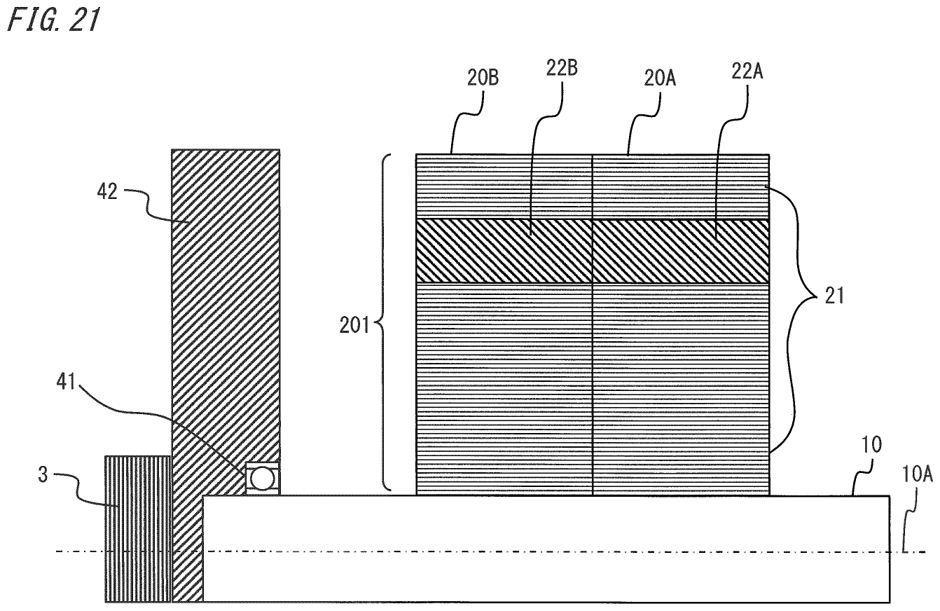

FIG. 20 is a sectional view schematically showing a structure of a rotary electric machine unit according to embodiment 7, and shows a cross-section along a plane including the axis of the rotary electric machine 1. FIG. 21 shows the details of a part of FIG. 20 and schematically shows a cross-section.

As shown in the drawings, a rotary electric machine unit 6 has a structure in which the rotary electric machine 1 and the inverter 3 for driving the rotary electric machine 1 are integrated with each other, and the inverter 3 is placed on one axial end side of the rotary electric machine 1.

In the present embodiment, the rotary electric machine 1 has the rotor 201 in which the first block 20A and the second block 20B are arranged in two stages in the axial direction. The components of the rotary electric machine 1 other than the rotor 201 are the same as those shown in FIG. 2 in the above embodiment 1. The structures of the first and second blocks 20A and 20B are also the same as those in the above embodiment 1 (see FIG. 5 and FIG. 6). The first block 20A has the first permanent magnet 22A, and the second block 20B has the second permanent magnet 22B.

As shown in the drawings, the inverter 3 is placed on the axial end side close to the second block 20B which is smaller in the heat generation amount. That is, the first block 20A which is larger in the heat generation amount is placed at a position far from the inverter 3, and the second block 20B which is smaller in the heat generation amount is placed at a position close to the inverter 3.

When the rotary electric machine 1 is driven, heat is generated not only on the rotary electric machine 1 side but also in the inverter 3. In the rotary electric machine unit 6 according to the present embodiment, since the first block 20A which is larger in the heat generation amount is placed at a position far from the inverter 3, a thermal influence from the inverter 3 to the first block 20A can be reduced.

Thus, heat release performance of the first permanent magnet 22A (high-heat-generation magnet) becomes greater than heat release performance of the second permanent magnet 22B (low-heat-generation magnet), so that the temperature distribution between the first block 20A and the second block 20B is uniformed, whereby the maximum temperature of the entire rotor 201 can be reduced.

Also in the above embodiment, as in the above embodiment 4, the first block 20A may be placed on the upstream side, the second block 20B may be placed on the downstream side, and the fluid 50A for cooling may flow in the axial direction, whereby the temperature distribution can be further uniformed.

As in the above embodiment 3 or the above embodiment 6, the fluid 50A for cooling may flow in the axial direction in the rotor 200 having the through hole 55, 55A. Also in this case, the first block 200A, 210A which is larger in the heat generation amount is placed at a position far from the inverter 3, whereby a thermal influence from the inverter 3 to the first block 200A, 210A can be reduced and thus the temperature distribution can be further uniformed.

### Embodiment 8

Next, embodiment 8 will be described with reference to the drawings. Here, the rotary electric machine 1 is described as a drive motor which mainly performs power-running operation.

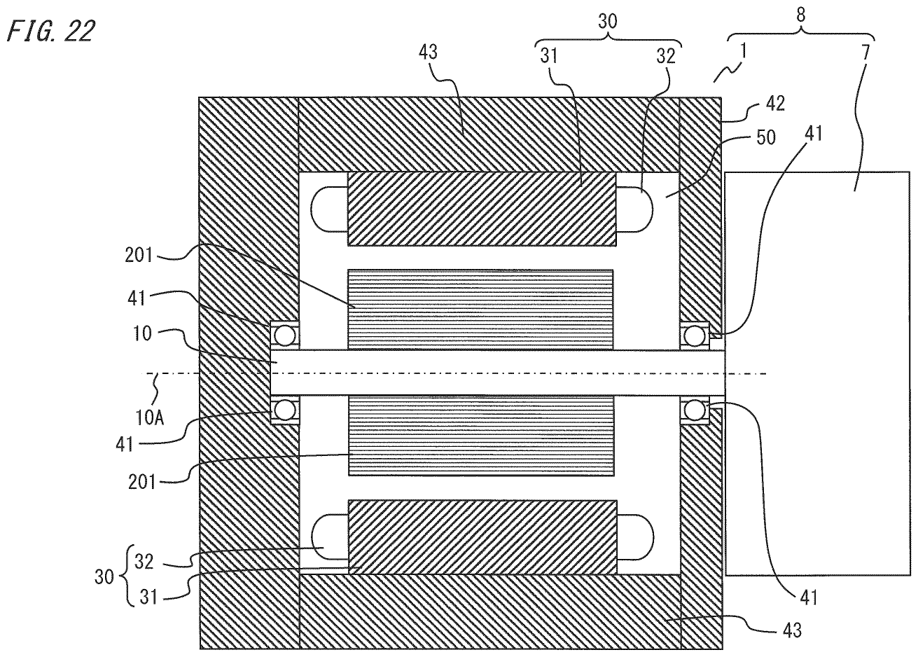

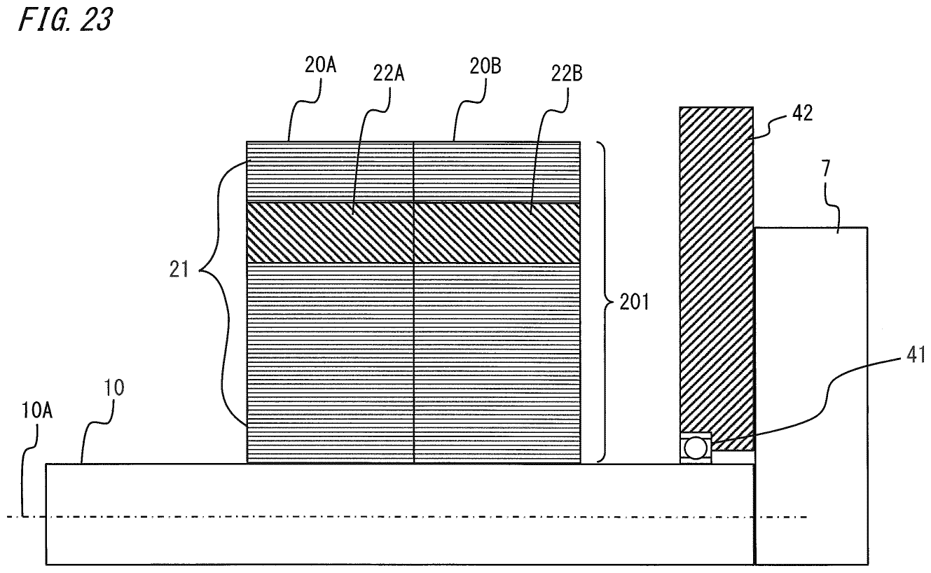

FIG. 22 is a sectional view schematically showing a structure of the rotary electric machine unit according to embodiment 8, and is a cross-section along a plane including the axis of the rotary electric machine 1. FIG. 23 shows the details of a part of FIG. 22 and schematically shows a cross-section.

As shown in FIG. 22, a rotary electric machine unit 8 includes the rotary electric machine 1 and a speed reducer 7 which is connected to the shaft 10 of the rotary electric machine 1 and adjusts the rotational speed, and the speed reducer 7 is placed on one axial end side of the rotary electric machine 1.

In the present embodiment, the rotary electric machine 1 has the rotor 201 in which the first block 20A and the second block 20B are arranged in two stages in the axial direction. The components of the rotary electric machine 1 other than the rotor 201 are the same as those shown in FIG. 2 in the above embodiment 1. The structures of the first and second blocks 20A and 20B are also the same as those in the above embodiment 1 (see FIG. 5 and FIG. 6). The first block 20A has the first permanent magnet 22A, and the second block 20B has the second permanent magnet 22B.

As shown in the drawings, the speed reducer 7 is placed on the axial end side close to the second block 20B which is smaller in the heat generation amount. That is, the first block 20A which is larger in the heat generation amount is placed at a position far from the speed reducer 7, and the second block 20B which is smaller in the heat generation amount is placed at a position close to the speed reducer 7.

When the rotary electric machine 1 is driven, heat is generated not only on the rotary electric machine 1 side but also in the speed reducer 7. In the rotary electric machine unit 8 according to the present embodiment, since the first block 20A which is larger in the heat generation amount is placed at a position far from the speed reducer 7, a thermal influence from the speed reducer 7 to the first block 20A can be reduced.

Thus, heat release performance of the first permanent magnet 22A (high-heat-generation magnet) becomes greater than heat release performance of the second permanent magnet 22B (low-heat-generation magnet), so that the temperature distribution between the first block 20A and the second block 20B is uniformed, whereby the maximum temperature of the entire rotor 201 can be reduced.

Also in the above embodiment, as in the above embodiment 4, the first block 20A may be placed on the upstream side, the second block 20B may be placed on the downstream side, and the fluid 50A for cooling may flow in the axial direction, whereby the temperature distribution can be further uniformed.

As in the above embodiment 3 or the above embodiment 6, the fluid 50A for cooling may flow in the axial direction in the rotor 200 having the through hole 55, 55A. Also in this case, the first block 200A, 210A which is larger in the heat generation amount is placed at a position far from the speed reducer 7, whereby a thermal influence from the inverter 3 to the first block 200A, 210A can be reduced and thus the temperature distribution can be further uniformed.

In the above embodiments 7 and 8, the rotary electric machine 1 is described as a drive motor which mainly performs power-running operation. However, the above embodiments 7 and 8 are also applicable to the rotary electric machine 1 serving as an electric generator which mainly performs regeneration operation. In this case, the second permanent magnet 22B becomes a high-heat-generation magnet, the first permanent magnet 22A becomes a low-heat-generation magnet, the second block 20B which is larger in the heat generation amount is placed on the upstream side of the fluid 50A in the axial direction, and the first block 20A which is smaller in the heat generation amount is placed on the downstream side. The inverter 3 (or speed reducer 7) which generates heat is placed on the axial end side close to the first block 20A which is smaller in the heat generation amount. That is, the second block 20B which is larger in the heat generation amount is placed at a position far from the inverter 3 (or speed reducer 7), and the first block 20A which is smaller in the heat generation amount is placed at a position close to the inverter 3 (or speed reducer 7).

Thus, as in the above embodiments 7 and 8, the temperature distribution between the first block 20A and the second block 20B is uniformed, whereby the maximum temperature of the entire rotor 201 can be reduced.

### Embodiment 9

Next, embodiment 9 will be described with reference to the drawings. The rotary electric machine 1 is described as a drive motor which mainly performs power-running operation.

In the above embodiments, the rotors 20, 200, 201 having blocks in a plurality of stages in the axial direction are used, whereas in the present embodiment, a rotor having a single structure in the axial direction is used.

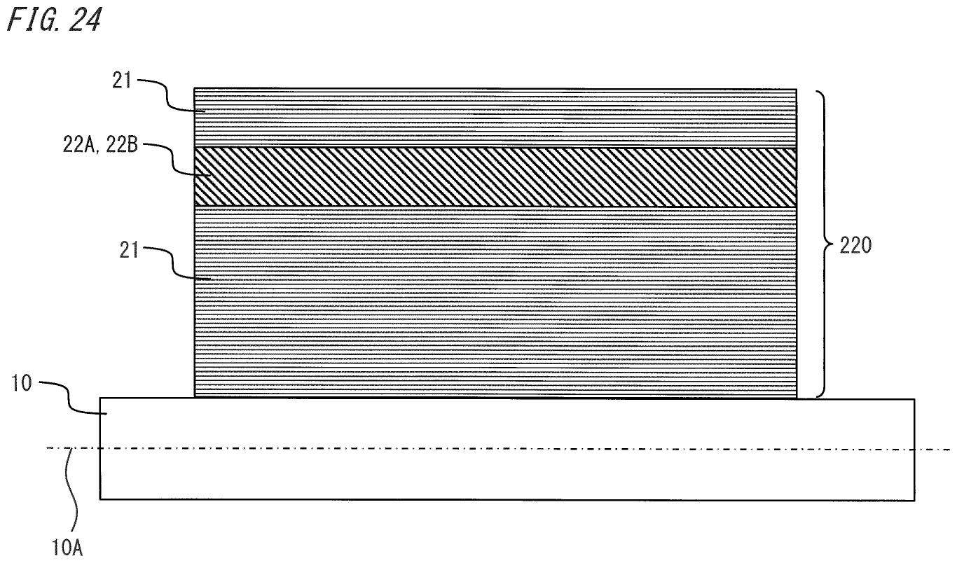

FIG. 24 is a sectional view showing a structure of the rotor according to embodiment 9, and schematically shows a cross-section along a plane including the axis 10A of the rotary electric machine 1.

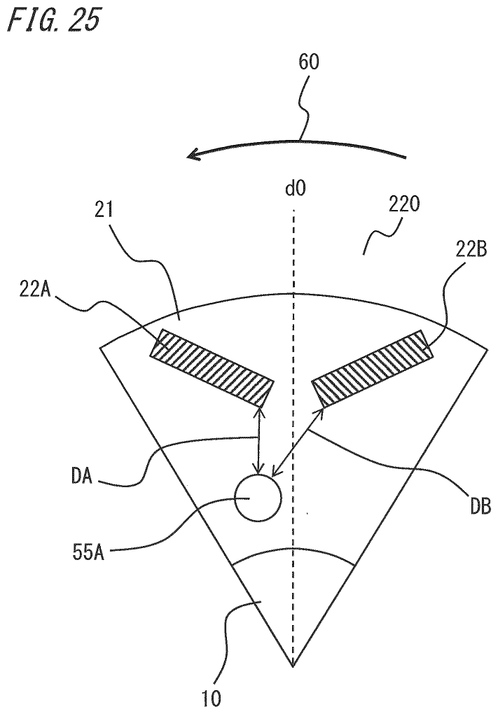

FIG. 25 is a sectional view showing a structure for one pole of the rotor, and shows a cross-section perpendicular to the axial direction.

As shown in FIG. 24 and FIG. 25, a rotor 220 includes the rotor core 21 and the first and second permanent magnets 22A and 22B, and is cooled by the fluid 51 which is oil flowing through the through hole 55A penetrating in the axial direction. The rotor 220 includes, for each pole, the first permanent magnet 22A placed at a position advanced in the forward rotation direction (arrow 60) of the rotor 220, the second permanent magnet 22B placed at a delayed position, and the through hole 55A through which the fluid 51 flows.

The first permanent magnet 22A and the second permanent magnet 22B are arranged symmetrically or substantially symmetrically with respect to the d axis do of the rotor 220. The through hole 55A is placed on the first permanent magnet 22A side with respect to the d axis do of the rotor 220. That is, the through hole 55A is provided at such a position that a distance DA from the through hole 55A to the first permanent magnet 22A is shorter than a distance DB from the through hole 55A to the second permanent magnet 22B.

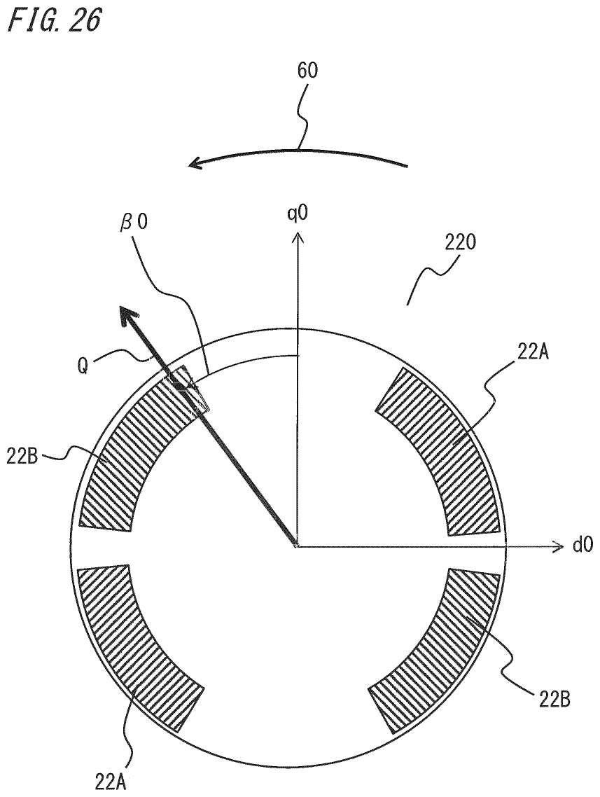

FIG. 26 shows a field magnet position in the rotor 220, using an electrical angle.

As described above, in a case where the rotary electric machine 1 performs power-running operation, operation is performed while a certain advance angle β (0°<β<90°) is given with the q axis q0 as a reference, for the purpose of utilization of reluctance torque or flux weakening control.

As shown in FIG. 26, the magnetic flux vector Q from the stator 30 has the advance angle 30 with the q axis q0 of the rotor 220 as a reference. With respect to the d axis do of the rotor 220, the first permanent magnet 22A is placed at a position advanced in the forward rotation direction (arrow 60), and the second permanent magnet 22B is placed at a position delayed in the forward rotation direction (arrow 60).

When the rotor 220 is driven at the advance angle β0, the second permanent magnet 22B is more strongly subjected to a field magnetic flux weakening effect than the first permanent magnet 22A. Therefore, the second permanent magnet 22B and the rotor core 21 therearound are smaller in the heat generation amount than the first permanent magnet 22A and the rotor core 21 therearound. That is, the first permanent magnet 22A is larger in the heat generation amount than the second permanent magnet 22B, the first permanent magnet 22A becomes a high-heat-generation magnet, and the second permanent magnet 22B becomes a low-heat-generation magnet.

On the other hand, heat transfer from the first and second permanent magnets 22A and 22B to the fluid 51 becomes greater as the distance to the fluid 51 becomes shorter. That is, heat is more drawn from the first permanent magnet 22A close to the through hole 55A through which the fluid 51 flows, than from the second permanent magnet 22B, so that heat release performance of the first permanent magnet 22A becomes higher.

In the present embodiment, the rotor 220 includes the first permanent magnet 22A and the second permanent magnet 22B for each pole, and the through hole 55A through which the fluid 51 flows in the axial direction is provided at a position closer to the first permanent magnet 22A (high-heat-generation magnet) than to the second permanent magnet 22B (low-heat-generation magnet), for each pole. Thus, heat generated in the first permanent magnet 22A more transfers to the fluid 51 flowing through the through hole 55A than heat generated in the second permanent magnet 22B, so that heat release performance of the first permanent magnet 22A becomes greater than heat release performance of the second permanent magnet 22B.

As described above, heat release performance of the first permanent magnet 22A which is larger in the heat generation amount can be made greater than heat release performance of the second permanent magnet 22B which is smaller in the heat generation amount, whereby the temperature distribution of the rotor 220 can be uniformed, the maximum temperature can be reduced, and size reduction and output increase of the rotary electric machine 1 can be achieved.

It is desirable that the through hole 55A is provided at a position that does not interfere with a magnetic circuit, and it is desirable that the distances DA and DB between the first and second permanent magnets 22A and 22B and the through hole 55A are selected so that the through hole 55A does not interfere with the magnetic circuit. For example, in a region in which the magnetic flux density is not greater than 0.1 [T] in the rotor core 21 when the through hole 55A is not provided, the through hole 55A is provided at such a position that the distance DA is as short as possible.

In order to make the magnet temperatures of the first permanent magnet 22A and the second permanent magnet 22B equal to each other, the ratio of the distance DA and the distance DB may be set to be the reciprocal of the ratio of the heat generation amounts of the first and second permanent magnets 22A and 22B.

In the above embodiment 9, the rotary electric machine 1 is described as a drive motor which mainly performs power-running operation. However, the above embodiment 9 is also applicable to the rotary electric machine 1 serving as an electric generator which mainly performs regeneration operation. In this case, the second permanent magnet 22B becomes a high-heat-generation magnet, the first permanent magnet 22A becomes a low-heat-generation magnet, and the through hole 55A is placed on the second permanent magnet 22B side with respect to the d axis do of the rotor 220. That is, the through hole 55A is provided at such a position that the distance from the through hole 55A to the second permanent magnet 22B is shorter than the distance from the through hole 55A to the first permanent magnet 22A.

Thus, heat release performance of the second permanent magnet 22B which is larger in the heat generation amount can be made greater than heat release performance of the first permanent magnet 22A which is smaller in the heat generation amount, and the temperature distribution of the rotor 220 can be uniformed, so that the maximum temperature can be reduced, whereby size reduction and output increase of the rotary electric machine 1 can be achieved.

### Embodiment 10

Next, embodiment 10 will be described with reference to the drawings. The rotary electric machine 1 is described as a drive motor which mainly performs power-running operation.

In the above embodiment 9, the rotor 220 includes one through hole 55A penetrating in the axial direction, for each pole, whereas in the present embodiment, a rotor includes two through holes.

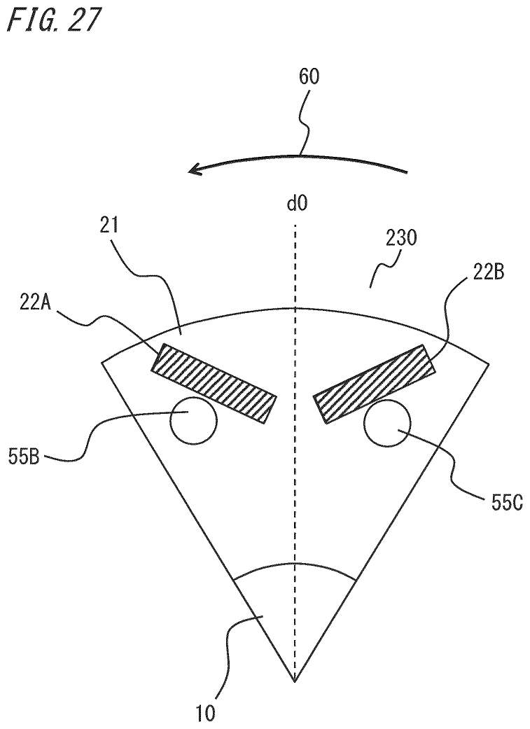

FIG. 27 is a sectional view showing a structure of the rotor according to embodiment 10, and schematically shows a cross-section along a plane including the axis 10A of the rotary electric machine 1.

Also in the present embodiment, a rotor 230 has a single structure in the axial direction, as in the above embodiment 9.

As shown in FIG. 27, the rotor 230 includes, for each pole, the first permanent magnet 22A placed at a position advanced in the forward rotation direction (arrow 60) of the rotor 230, the second permanent magnet 22B placed at a delayed position, and a first through hole 55B and a second through hole 55C through which the fluid 51 flows.

The first permanent magnet 22A and the second permanent magnet 22B are arranged symmetrically or substantially symmetrically with respect to the d axis do of the rotor 230. The first through hole 55B is placed on the first permanent magnet 22A side with respect to the d axis do of the rotor 230, and the second through hole 55C is placed on the second permanent magnet 22B side with respect to the d axis do of the rotor 230.

The first through hole 55B and the second through hole 55C are arranged symmetrically or substantially symmetrically with respect to the d axis do of the rotor 230. The fluid 51 for cooling the rotor 230 flows through the first through hole 55B and the second through hole 55C in the same direction along the axial direction, but the flowing speed in the first through hole 55B is set to be greater than the flowing speed in the second through hole 55C.

The first permanent magnet 22A is larger in the heat generation amount than the second permanent magnet 22B, the first permanent magnet 22A becomes a high-heat-generation magnet, and the second permanent magnet 22B becomes a low-heat-generation magnet.

In the present embodiment, the rotor 230 includes the first permanent magnet 22A and the second permanent magnet 22B for each pole, and the first through hole 55B and the second through hole 550 through which the fluid 51 flows in the axial direction are provided for each pole. For the fluid 51 flowing in the axial direction, the flow rate in the first through hole 55B is set to be greater than the flow rate in the second through hole 55C. That is, the fluid 51 flows at a high speed through the first through hole 55B placed close to the first permanent magnet 22A (high-heat-generation magnet) which is larger in the heat generation amount, and flows at a low speed through the second through hole 55C placed close to the second permanent magnet 22B (low-heat-generation magnet) which is smaller in the heat generation amount.

Heat transfer from a solid to a fluid increases as the flow rate increases. Therefore, heat generated in the first permanent magnet 22A more transfers to the fluid 51 than heat generated in the second permanent magnet 22B, so that heat release performance of the first permanent magnet 22A becomes greater than heat release performance of the second permanent magnet 22B.

Thus, heat release performance of the first permanent magnet 22A which is larger in the heat generation amount can be made greater than heat release performance of the second permanent magnet 22B which is smaller in the heat generation amount, and the temperature distribution of the rotor 230 can be uniformed, so that the maximum temperature can be reduced, whereby size reduction and output increase of the rotary electric machine 1 can be achieved.

In the present embodiment, since the rotor 230 can be formed with a structure symmetric with respect to the d axis do, designing of the magnetic circuit is easy.

A method for setting the positions of the first and second through holes 55B and 55C is not limited as long as they are symmetric with respect to the d axis do of the rotor 230. For example, flux barriers on the magnetic circuit can be utilized as the first and second through holes 55B and 55C.

In the above embodiment 10, the rotary electric machine 1 is described as a drive motor which mainly performs power-running operation. However, the above embodiment 10 is also applicable to the rotary electric machine 1 serving as an electric generator which mainly performs regeneration operation. In this case, the second permanent magnet 22B becomes a high-heat-generation magnet, the first permanent magnet 22A becomes a low-heat-generation magnet, and for the fluid 51 flowing in the axial direction, the flow rate in the second through hole 55C is set to be greater than the flow rate in the first through hole 55B. That is, the fluid 51 flows at a high speed through the second through hole 55C placed close to the second permanent magnet 22B (high-heat-generation magnet) which is larger in the heat generation amount, and flows at a low speed through the first through hole 55B placed close to the first permanent magnet 22A (low-heat-generation magnet) which is smaller in the heat generation amount.

Thus, heat release performance of the second permanent magnet 22B which is larger in the heat generation amount can be made greater than heat release performance of the first permanent magnet 22A which is smaller in the heat generation amount, and the temperature distribution of the rotor 230 can be uniformed, so that the maximum temperature can be reduced, whereby size reduction and output increase of the rotary electric machine 1 can be achieved.

In the present embodiment, the rotary electric machine 1 may be provided with a flow rate switch 9 which switches the flow rate of the fluid 51, as described below.

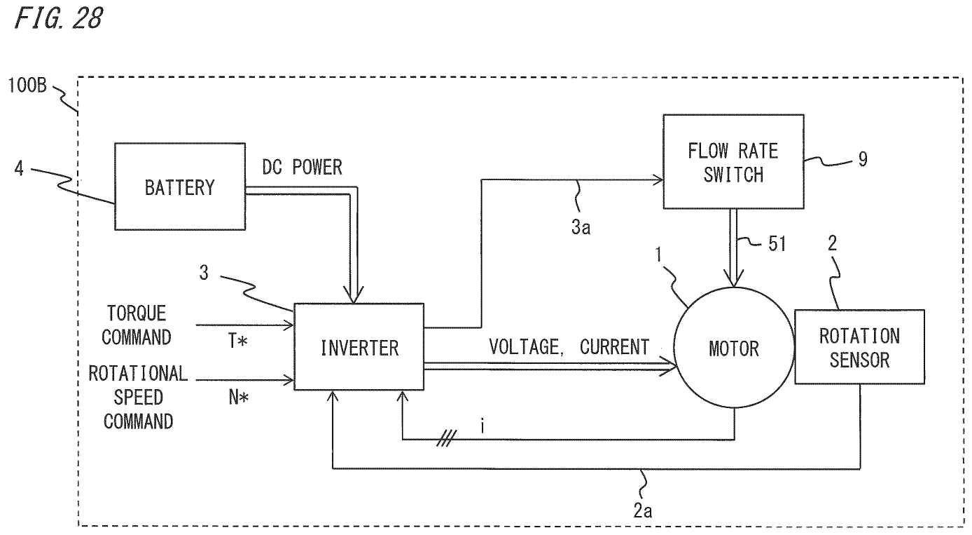

FIG. 28 is a block diagram showing a system configuration of an electric vehicle in another example of embodiment 10. As shown in FIG. 28, an electric vehicle 100B includes the rotary electric machine 1, the rotational sensor 2, the inverter 3, the battery 4, and the flow rate switch 9 provided to the rotary electric machine 1.

When the rotary electric machine 1 switches between power-running operation and regeneration operation, the flow rate switch 9 inverts the magnitude relationship between the speed of the fluid 51 flowing through the first through hole 55B and the speed of the fluid 51 flowing through the second through hole 55C.

When the driving condition of the rotary electric machine 1 changes from power-running operation to regeneration operation, the inverter 3 gives a switchover command 3a to the flow rate switch 9, so that the flow rate switch 9 decreases the flow rate of the fluid 51 flowing through the first through hole 55B and increases the flow rate of the fluid 51 flowing through the second through hole 55C. That is, the flow rate switch 9 performs switchover so that the flow rate of the fluid 51 flowing through the first through hole 55B becomes smaller than the flow rate of the fluid 51 flowing through the second through hole 55C.

In power-running operation of the rotary electric machine 1, the heat generation amount in the first permanent magnet 22A is larger, and in regeneration operation, the heat generation amount in the second permanent magnet 22B is larger. In this case, since the flow rate switch 9 is provided to the rotary electric machine 1, it is possible to effectively cool the rotor 230 not only in power-running operation but also in regeneration operation.

As described above, by providing the flow rate switch 9, the rotor 230 can be effectively cooled in both of power-running operation and regeneration operation. Thus, in any of cases where the rotary electric machine 1 mainly performs power-running operation, mainly performs regeneration operation, or performs both operations to equal extents, the rotor 230 can be effectively cooled in the same manner.

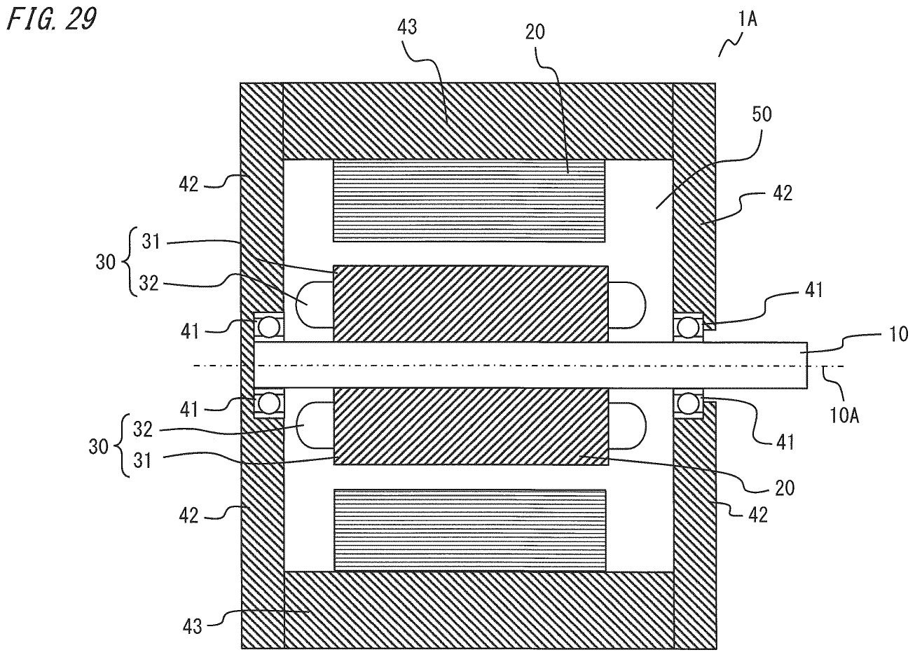

In the above embodiment 1, the rotary electric machine 1 of an inner rotor type in which the stator 30 is provided on the outer side of the rotor 20 has been shown. However, in embodiments 1 to 10, a rotary electric machine of an outer rotor type as shown in FIG. 29 may be used, whereby the same effects are obtained.

FIG. 29 is a sectional view schematically showing a structure of the rotary electric machine 1A, and shows a cross-section along a plane including the axis of the rotary electric machine 1A.

As shown in FIG. 29, a rotary electric machine 1A includes the columnar shaft 10, the cylindrical rotor 20, and the cylindrical stator 30 provided on the inner side of the rotor 20 with a gap therebetween. The rotor 20 and the stator 30 are arranged concentrically on the axis 10A. The shaft 10 is rotatably supported by the bearings 41, the bearings 41 are fitted to the brackets 42, and the brackets 42 are fastened to the housing 43 using fastening means such as screws or the like.

The stator 30 is an armature including the stator core 31 and the coil 32 wound around each tooth (not shown) of the stator core 31.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1, 1A rotary electric machine
3 inverter
5 flow path switch
6 rotary electric machine unit
7 speed reducer
8 rotary electric machine unit
9 flow rate switch
20 rotor
20A first block
20B second block
22A first permanent magnet
22B second permanent magnet
30 stator
31 stator core
31A axial-direction end region
31B axial-direction center region
31AA, 31BA, 31BB tooth portion
32 coil
50 air
50A fluid
51 fluid
55, 55A through hole
55B first through hole
55C second through hole
100, 100A, 100B electric vehicle
200 rotor
200A first block
200B second block
201 rotor
210A first block
210B second block
220 rotor
d0 d axis of rotor

1. A rotary electric machine comprising:
a cylindrical rotor including at least one first permanent magnet and at least one second permanent magnet, for each pole; and
a cylindrical stator including a stator core and a winding and placed with a gap between the stator and the rotor, wherein
the first permanent magnet is placed at a position advanced in a forward rotation direction of the rotor with respect to a d axis of the rotor, and the second permanent magnet is placed at a position delayed in the forward rotation direction of the rotor with respect to the d axis of the rotor,
on the basis of a difference between heat generation levels of the first permanent magnet and the second permanent magnet which generate heat through operation of the rotary electric machine, one of the first and second permanent magnets is defined as a high-heat-generation magnet, and the other is defined as a low-heat-generation magnet, and
the rotor is formed with heat release performance of the high-heat-generation magnet made greater than heat release performance of the low-heat-generation magnet, and is cooled by heat transfer via a fluid.

2. The rotary electric machine according to claim 1, wherein
the rotor includes blocks arranged in a plurality of stages in an axial direction and composed of at least one first block having the first permanent magnet for each pole and at least one second block having the second permanent magnet for each pole, and
of the blocks in the plurality of stages, the block having the high-heat-generation magnet is placed on an axial-direction end side, and the block having the low-heat-generation magnet is placed on an axial-direction center side.

3. The rotary electric machine according to claim 2, wherein
the stator core has tooth portions protruding toward the rotor side and formed by being stacked in the axial direction, and
at least one of a distal end width and a base end width of the tooth portion in an axial-direction end region is smaller than that of the tooth portion in an axial-direction center region.

4. The rotary electric machine according to claim 1, wherein
the fluid flows in an axial direction and cools the rotor,
the rotor includes a first block having the first permanent magnet for each pole and a second block having the second permanent magnet for each pole, the first and second blocks being arranged in the axial direction, and
of the first and second blocks, the block having the high-heat-generation magnet is placed on an upstream side of the fluid, and the block having the low-heat-generation magnet is placed on a downstream side of the fluid.

5. The rotary electric machine according to claim 4, wherein
the rotor includes a through hole penetrating in the axial direction, for each pole, and
the fluid flows through the through hole.

6. The rotary electric machine according to claim 4- or 5, further comprising a switch which inverts a flowing direction of the fluid, wherein
a direction of the fluid is inverted at a time of switchover between power-running operation and regeneration operation of the rotary electric machine.

7. The rotary electric machine according to claim 1, wherein
the rotor includes a through hole penetrating in an axial direction, for each pole,
the fluid flows through the through hole and cools the rotor, and
the through hole is provided at such a position that a distance from the through hole to the high-heat-generation magnet is shorter than a distance from the through hole to the low-heat-generation magnet.

8. The rotary electric machine according to claim 7, wherein
the rotor includes the first permanent magnet and the second permanent magnet arranged symmetrically with respect to the d axis, for each pole.

9. The rotary electric machine according to claim 1, wherein
the rotor includes the first permanent magnet and the second permanent magnet arranged symmetrically with respect to the d axis, for each pole, and further includes a first through hole and a second through hole penetrating in an axial direction, for each pole,
the fluid flows through the first through hole and the second through hole in the same direction and cools the rotor,
the first through hole is placed on the first permanent magnet side of the d axis, the second through hole is placed on the second permanent magnet side of the d axis, and the first through hole and the second through hole are arranged symmetrically with respect to the d axis, and
of the first and second through holes, a speed of the fluid flowing through the through hole on the high-heat-generation magnet side is greater than a speed of the fluid flowing through the through hole on the low-heat-generation magnet side.

10. The rotary electric machine according to claim 9, further comprising a switch which switches the speed of the fluid, wherein
a magnitude relationship between the speed of the fluid flowing through the first through hole and the speed of the fluid flowing through the second through hole is inverted at a time of switchover between power-running operation and regeneration operation of the rotary electric machine.

11. The rotary electric machine according to claim 1, wherein
the rotary electric machine is a motor which mainly performs power-running operation,
the high-heat-generation magnet is the first permanent magnet, and
the low-heat-generation magnet is the second permanent magnet.

12. The rotary electric machine according to claim 1, wherein
the rotary electric machine is an electric generator which mainly performs regeneration operation,
the high-heat-generation magnet is the second permanent magnet, and
the low-heat-generation magnet is the first permanent magnet.

13. A rotary electric machine unit comprising:
the rotary electric machine according to claim 1; and
an inverter which performs drive control for the rotary electric machine, wherein
the rotor includes a first block having the first permanent magnet for each pole and a second block having the second permanent magnet for each pole, the first and second blocks being arranged in an axial direction, and
the inverter is placed on one axial end side of the rotary electric machine which is a side close to the block having the low-heat-generation magnet, of the first and second blocks.

14. A rotary electric machine unit comprising:
the rotary electric machine according to claim 4; and
an inverter which performs drive control for the rotary electric machine, wherein
the inverter is placed on an axial end side on a downstream side of the fluid, with respect to the rotary electric machine.

15. A rotary electric machine unit comprising:
the rotary electric machine according to claim 6; and
an inverter connected to the rotary electric machine, wherein
the switch performs switchover operation in accordance with a switchover command from the inverter.

16. A rotary electric machine unit comprising:
the rotary electric machine according to claim 1; and
a speed reducer connected to the rotary electric machine, wherein
the rotor includes a first block having the first permanent magnet for each pole and a second block having the second permanent magnet for each pole, the first and second blocks being arranged in an axial direction, and
the speed reducer is placed on one axial end side of the rotary electric machine which is a side close to the block having the low-heat-generation magnet, of the first and second blocks.

17. A rotary electric machine unit comprising:
the rotary electric machine according to claim 4; and
a speed reducer connected to the rotary electric machine, wherein
the speed reducer is placed on an axial end side on a downstream side of the fluid, with respect to the rotary electric machine.

18. The rotary electric machine unit according to claim 13, wherein
the rotary electric machine is a motor which mainly performs power-running operation, the high-heat-generation magnet is the first permanent magnet, and the low-heat-generation magnet is the second permanent magnet.

19. The rotary electric machine unit according to claim 13, wherein
the rotary electric machine is an electric generator which mainly performs regeneration operation, the high-heat-generation magnet is the second permanent magnet, and the low-heat-generation magnet is the first permanent magnet.

20. An electric vehicle comprising the rotary electric machine according to claim 1, and driven by the rotary electric machine, wherein
the forward rotation direction of the rotor is a main rotation direction and is a rotation direction when the electric vehicle moves forward.
